(19) United States
(12) Patent Application Publication
(10) Pub. No.: US 2013/0325555 A1
(43) Pub. Date: Dec. 5, 2013

(54) SYSTEM AND METHOD FOR GENERATING PRICING INFORMATION

(71) Applicant: Kurt L. Kimmerling, New York, NY (US)

(72) Inventor: Kurt L. Kimmerling, New York, NY (US)

(21) Appl. No.: 13/905,625

(22) Filed: May 30, 2013

Related U.S. Application Data
(63) Continuation-in-part of application No. 13/795,168, filed on Mar. 12, 2013.
(60) Provisional application No. 61/654,119, filed on Jun. 1, 2012.
(60) Provisional application No. 61/683,752, filed on Aug. 16, 2012.
(60) Provisional application No. 61/683,750, filed on Aug. 16, 2012.
(60) Provisional application No. 61/800,338, filed on Mar. 15, 2013.

(51) Int. Cl. G06Q 30/02

(52) U.S. Cl. CPC G06Q 30/0283
USPC 705/7.35

(57) ABSTRACT

A pricing method and system may be configured for reducing the dimensionality of item preference data to obtain item preferences of items; simulating preferences of users with the item preferences; and simulating user decisions with the simulated user preferences to generate simulated pricing information.

### CROSS-REFERENCE TO RELATED APPLICATIONS

This application claims the benefit of priority from U.S. Patent Application Ser. Nos. 61/654,119, filed on Jun. 1, 2012; 61/683,750, filed on Aug. 16, 2012; 61/683,752, filed on Aug. 16, 2012; Ser. Nos. 13/795,168, filed on Mar. 12, 2013; and 61/800,338, filed on Mar. 15, 2013, the disclosures of all said applications expressly incorporated by reference herein in their entirety.

### FIELD OF THE DISCLOSURE

The disclosure relates generally to a system and a method for generating pricing information. More particularly, the disclosure relates to a system and a method for generating pricing information applying dimensionality reduction analysis techniques.

### BACKGROUND OF THE DISCLOSURE

Understanding user preferences is desirable to target advertising information and to improve user experiences while users engage web pages and mobile device applications. The value of predicted user preferences increases with their ability to predict user actions, such as purchasing decisions. User preferences can be inferred from implicit information by searching through user information such as purchasing history, credit card usage, demographic information, and other types of public and proprietary information. Such inferences are based on a large volume of information seemingly unrelated to the action to be predicted.

User preferences can also be obtained directly from users. For example, users can be asked to rank items. Ranked ordered data is useful. However, ranking items can require a significant amount of time and many users are unwilling or unable to spend the necessary time.

A need exists to obtain information from users quickly and efficiently. Further, a need exists to improve business results based on better user preference information.

### SUMMARY OF THE DISCLOSURE

A method and a system for generating pricing information and making pricing recommendations are disclosed. The method is executable at least in part by a processing device according to processing instructions embedded in one or more non-transitory computer readable medium. In one embodiment, the method is configured for accessing a data-structure including a plurality of items and generating pricing information based on information about the plurality of items. Pricing information includes item prices; preference-price efficient items; relative demand for an item; price elasticity for an item; cross-price elasticity for demand of an item and a price of a second item; a demand curve for an item; demand curves for an item corresponding to different subpopulations; and any other information suitable for making pricing decisions. The pricing information may be based on simulated preferences of users and simulated user decisions. The demand curve for an item is simulated by determining the relative demand for the item at each of a plurality of prices. The results of the simulation provide simulated user preferences and prices that would influence the purchasing behavior of actual users. With the demand curve, pricing sensitivities may be determined. The pricing information may be accessed by or output to a merchant to implement pricing strategies developed for specific user and user subgroups based on user preferences. The pricing strategies may include upcharging and discounting of items.

In a further embodiment, the pricing method comprises accessing item preference data; reducing the dimensionality of the item preference data to obtain item preferences of items; simulating preferences of users with the item preferences; and simulating user decisions with the simulated user preferences to generate simulated pricing information. In the present embodiment, the pricing method is executable at least in part by a processing device according to processing instructions embedded in one or more non-transitory computer readable medium.

In a yet further embodiment, the pricing method comprises identifying a user based on website access information; outputting information about the user to a reduced dimensionality preference simulation application via an information network, the reduced dimensionality preference simulation application configured to simulate preferences of users based on reduced dimensionality item preference data and generate simulated pricing information with the information about the user and the simulated preferences of users; receiving the simulated pricing information from the reduced dimensionality preference simulation application; and offering a price for an item to the user based on the simulated pricing information. In the present embodiment, the pricing method is executable at least in part by a processing device according to processing instructions embedded in one or more non-transitory computer readable medium.

Also presented herein are embodiments of a non-transitory computer readable medium and a system including the non-transitory computer readable medium, the non-transitory computer readable medium having processing instructions embedded therein for implementing the foregoing methods when processed by a processing device. In addition to the non-transitory computer readable medium and the processing instructions, the system includes the processing device.

In another variation, the pricing system comprises one or more physical servers; a web server software residing in the one or more physical servers and operable to output item information including item prices for viewing by potential customers; and a pricing software module operable to receive simulated pricing information and generate the item information based on the simulated pricing information, the simulated pricing information generated by a reduced dimensionality preference simulation application operable to reduce the dimensionality of item preference data to obtain item preferences of items, simulate preferences of users with the item preferences, and simulate user decisions with the simulated user preferences to generate the simulated pricing information. The web server software is further operable to process an item transaction based on the item prices presented for viewing by the potential customers.

### BRIEF DESCRIPTION OF THE DRAWINGS

The above-mentioned and other disclosed features, and the manner of attaining them, will become more apparent and will be better understood by reference to the following description of disclosed embodiments taken in conjunction with the accompanying drawings, wherein:

FIG. 1 is a block diagram of an information elicitation and transaction facilitation system according with an example set forth in the disclosure;

FIG. 2 is a graph illustrative of an information elicitation method according with an example set forth in the disclosure;

FIGS. 3 and 3A are block diagrams of information elicitation systems according with examples set forth in the disclosure;

FIG. 4 is a flowchart depicting a recommendation method according with yet another example set forth in the disclosure;

FIG. 5 is a flowchart depicting another recommendation method according with an example set forth in the disclosure.

FIG. 6 is a block diagram of a recommendation and transaction facilitation system according with another example set forth in the disclosure;

FIG. 7 is a flowchart depicting another recommendation and transaction facilitation method according with an example set forth in the disclosure;

FIG. 8 is a block diagram of a transaction facilitation system according with an example set forth in the disclosure;

FIGS. 9 and 10 are preference/price graphs illustrating an embodiment of a pricing recommendation method according with a further example set forth in the disclosure; and

FIG. 11 is a flowchart illustrating an embodiment of a pricing method according with a yet further example set forth in the disclosure.

Corresponding reference characters indicate corresponding parts throughout the several views. Although the drawings represent embodiments of various features and components according to the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE DISCLOSURE

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

A method and a system for generating pricing information and/or making pricing recommendations are disclosed. Item preference data is statistically analyzed to generate a reduced dimensionality item preference data. The reduced dimensionality preference simulation application uses the reduced dimensionality item preference data and user preference data to generate the pricing information. Pricing information includes item prices; preference-price efficient items; relative demand for an item; price elasticity for an item; cross-price elasticity for demand of an item and a price of a second item; a demand curve for an item; demand curves for an item corresponding to different subpopulations; and any other information suitable for making pricing decisions.

The pricing recommendations may be based on explicit user preference data. Explicit user preference data may be obtained with a system and method for soliciting information as described in commonly owned U.S. patent application Ser. No. 13/795,168, filed Mar. 12, 2013, titled “System and Method for Eliciting Information,” said application incorporated in its entirety herein by reference.

The pricing information may be based on simulated preferences of users and simulated user decisions. The demand curve for an item is simulated by determining the relative demand for the item at each of a plurality of prices. The results of the simulation provide simulated user preferences and prices that would influence the purchasing behavior of actual users. The user preferences of actual users can be matched to simulated user preferences to predict the behavior of the actual users. Pricing sensitivities may be determined with the demand curve. The pricing information may be accessed by or output to a merchant to implement pricing strategies developed for specific user and user subgroups based on user preferences. The pricing strategies may include upcharging and discounting of items.

The system may include an application programming interface (API) hosted by a web server. The API may access the reduced dimensionality preference simulation application to generate pricing information based on item preference data. Online vendors may utilize their own web servers and databases to access the API and use the pricing information generated by the reduced dimensionality preference simulation application to promote transactions involving items they trade in commerce. For example, online vendors may use the pricing information to recommend items and services to a user and to implement targeted pricing based on user preferences. The user may then rent or purchase a recommended item. The owner of the information elicitation system may grant access to the API to the online vendors in exchange for fees or other benefits.

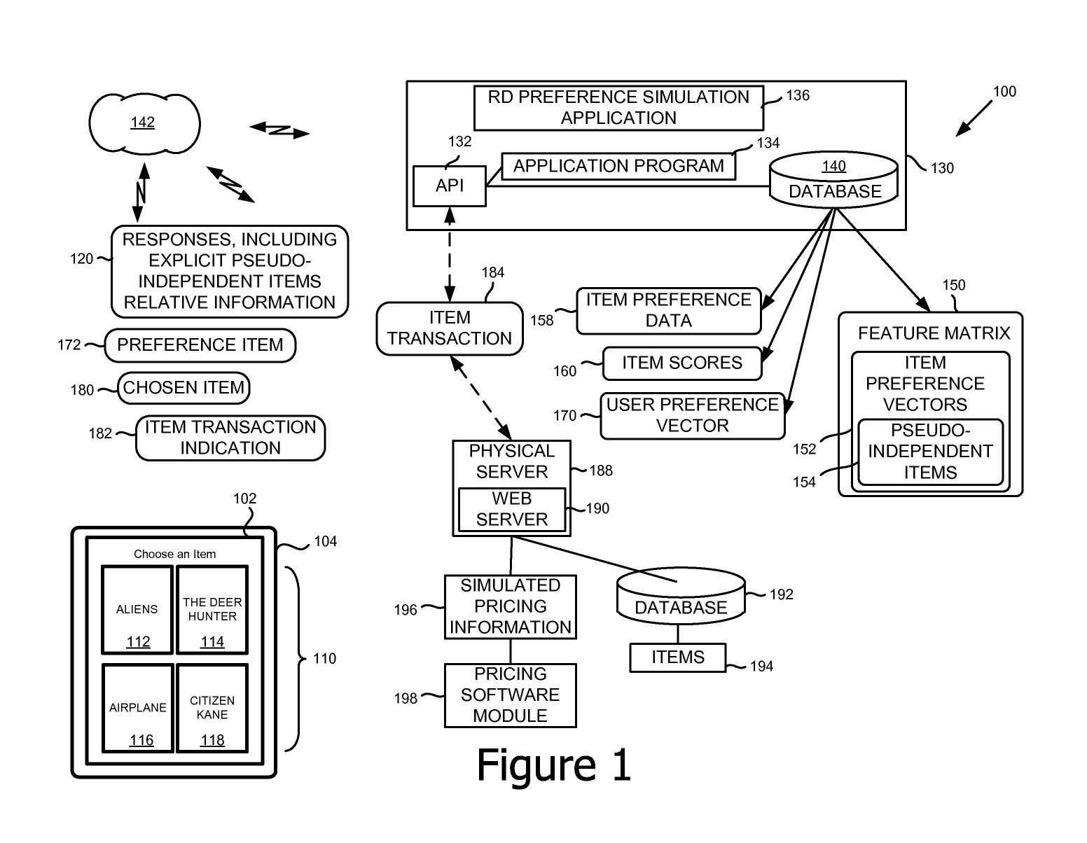

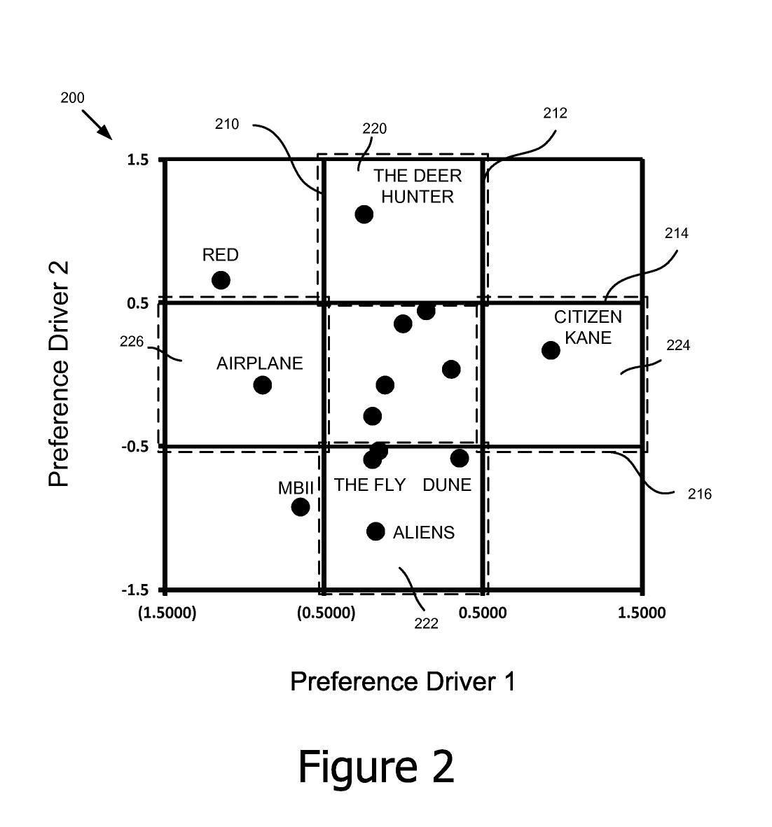

FIGS. 1 and 2 are block diagrams of embodiments of a system and method for eliciting information from a user to promote an online transaction. FIG. 1 is a block diagram of an embodiment of an information elicitation system 100 including a user application 102 residing in a user device 104, and a system 130. The present embodiment may be described below with reference to movie items, although the embodiment is not limited to movies. Other items include songs, photos, software, any other digital content, and items that require physical delivery. System 130 may comprise one or more servers, such as a web server and a database server. System 130 is configured to transmit questions 110 to user application 102. A question 110 to solicit explicit pseudo-independent items relative information may include representations 112, 114, 116 and 118 corresponding to four items. Representations 112, 114, 116 and 118 may include text or images. The titles of four movies are shown (Aliens, The Deer Hunter, Airplane and Citizen Kane). User application 102 receives responses to the questions from the user and transmits responses 120 to system 130 via an information network 142. A response 120 may comprise, for example, an indication that the user chose the movie Aliens, the choice being explicit pseudo-independent items relative information. Based on responses 120, system 130 generates scores for the items. The scores represent the user's preferences. In one example, the highest score corresponds to the item most likely preferred by the user based on his/her responses.

System 130 may include an API 132, an application program 134, and a database 140. Database 140 may include item preference data 158 and item scores 160 computed based on a user preference vector 170, which is computed by processing responses 120. Database 140 may also include a feature matrix 150 including item preference vectors 152 obtained from item preference data 158. Pseudo-independent items 154 are determined from item preference vectors 152 to generate questions 110.

System 130 may also include a reduced dimensionality preference simulation application 136 accessible by a pricing software module 198 of an online vendor. The vendor may transfer user identification information to reduced dimensionality preference simulation application 136 and receive simulated pricing information 196 in return. With simulated pricing information 196, which may be based on the user identification information and therefore targeted to the user, the vendor can make pricing recommendations to the user, and other users with similar preferences, to engage in item transactions. Application program 134 may include reduced dimensionality preference simulation application 136.

In one variation of an embodiment of a recommendation system, system 130 transmits a recommendation to user application 102 including one or more preference item 172. The user can choose one of the one or more preference item 172 and initiate an item transaction 184 with user application 102. Upon the initiation, a chosen item 180 and an item transaction indication 182 are transmitted to a web server 190, which resides in a physical server 188 of an online vendor to execute item transaction 184. Web server 190 may include a database 192 including a multitude of items 194. Preference item 172 may be selected from items 194 to ensure the online vendor can supply chosen item 180. As used herein, items 194 include digital items and item identifiers corresponding to physical and/or digital items.

In one variation, the questions are determined from pseudo-independent item pools based on thresholds. FIG. 2. shows a graph 200 illustrating preference driver values corresponding to items (e.g. movies). The preference driver values are computed from item preference data 158. Each item has a preference driver 1 value and a preference driver 2 value. A circular symbol is shown in graph 200 at the intersection of the preference driver values for each movie. Graph 200 includes thresholds 210, 212 corresponding to preference driver 1 and thresholds 214, 216 corresponding to preference driver 2. Graph 200 also includes pseudo-independent item pool areas 220, 222, corresponding to positive and negative pool areas for preference driver 2, respectively, and pseudo-independent item pool areas 224, 226, corresponding to positive and negative pool areas for preference driver 1, respectively. Pool areas 220, 222, 224, 226 are defined by thresholds 210, 212, 214, 216. The pool areas do not include the center and corner areas of graph 200. Movies graphed in the pseudo-independent item pool areas exhibit relatively large positive or negative values for one preference driver, indicating high preference, and relatively small positive or negative values for the other preference driver, indicating mild or neutral preference. Fourteen symbols are shown corresponding to fourteen movies. The values for each movie are shown in Table 1 below.

TABLE 1

| Movies | Driver 1 | Driver 2 |
|---|---|---|
| Red | (1.1500) | 0.6610 |
| Airplane | (0.8883) | (0.0700) |
| MBII | (0.6500) | (0.9200) |
| The Deer Hunter | (0.2500) | 1.1200 |
| The Fly | (0.1973) | (0.5897) |
| A Beautiful Mind | (0.1973) | (0.2870) |
| Aliens | (0.1768) | (1.0900) |
| Juno | (0.1579) | (0.5289) |
| Aladdin | (0.1185) | (0.0700) |
| Shark | (0.0055) | 0.3570 |
| Braveheart | 0.1401 | 0.4475 |
| Mars Attacks! | 0.2980 | 0.0393 |
| Dune | 0.3500 | (0.5800) |
| Citizen Kane | 0.9243 | 0.1715 |

As shown in Table 1, the values for the movie The Deer Hunter (graphed in pseudo-independent item pool area 220) are (0.2500) and 1.1200, which indicate a strong positive preference for preference driver 2 and a mild or almost neutral preference for preference driver 1. The values for the movie Aliens (graphed in pseudo-independent item pool area 222) are (0.1768) and (1.0900), which indicate a strong negative preference for preference driver 2 and a mild or almost neutral preference for preference driver 1. The movies graphed in a pseudo-independent item pool area comprise a pseudo-independent item pool, positive or negative. In the present example, the pseudo-independent item pools for preference driver 1 include the movies Citizen Kane (positive pool) and Airplane (negative pool). The pseudo-independent item pools for preference driver 2 include the movies The Deer Hunter (positive pool) and The Fly, Dune, Juno and Aliens (negative pool). Questions are drawn from the positive and negative pools.

The item preference data is initially obtained from respondents and is statistically analyzed to generate a reduced dimensionality item preference data, which includes the preference drivers and the preference driver values discussed with reference to FIG. 2. The reduced dimensionality item preference data may be structured as a matrix, which may be referred to as a feature matrix of item preference vectors. The item preference data includes a listing of items previously experienced or judged by respondents and item drivers obtained based on the respondent's experience or judgment. As used herein, a respondent is an individual providing input for the determination of item drivers, and a user is an individual that provides survey information. In a recommendation system, the user is also the recipient of the recommendation. In the case of a group of users, one, more than one, or all of the users are also recipients of the recommendation.

The foregoing embodiments of the system and method for eliciting information may be used to make recommendations. Individual preferences vary between individuals and between items being considered by the individuals. Preferences can be correlated and can be determined based on individual preference drivers. The ability to define items to make a recommendation based on a handful of independent drivers is very powerful. Input from respondents can be analyzed to identify the most important uncorrelated preference drivers for a group of individuals. Principal component analysis, matrix factorization, and singular value decomposition are exemplary known analytical techniques for identifying drivers. After input from respondents is analyzed using these techniques, the preferences of any individual can be summarized with a vector of real numbers. For example, a user's preference vector [1.3, −0.2, −1.8, 0.1], where each number represents a preference of the user for each driver, indicates the user likes driver 1, dislikes driver 3, and does not have a strong preference, positive or negative, for drivers 2 and 4. Likewise, an item can also be summarized with a vector of real numbers, wherein each number represents the degree to which the item exhibits the corresponding driver. The product of the individual's preference vector and the item's vector is indicative of how much the individual should like the item, with higher numbers indicating an item that should be more preferred. An item's vector can also be viewed as a point in space, wherein closely spaced points indicate similarly preferred items.

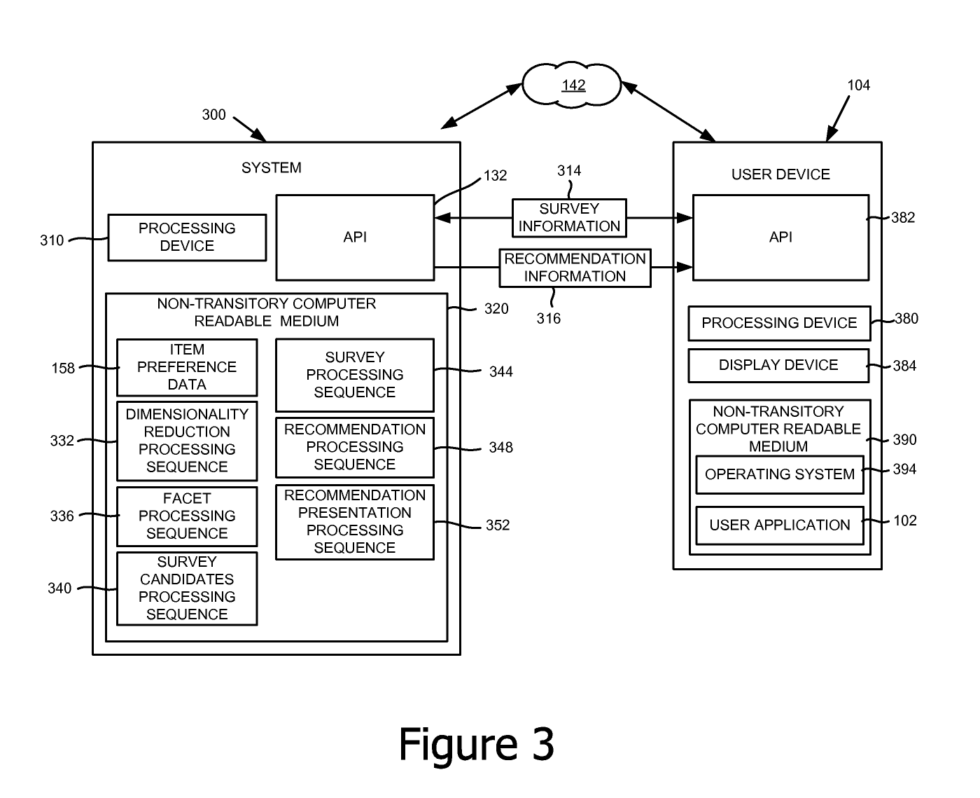

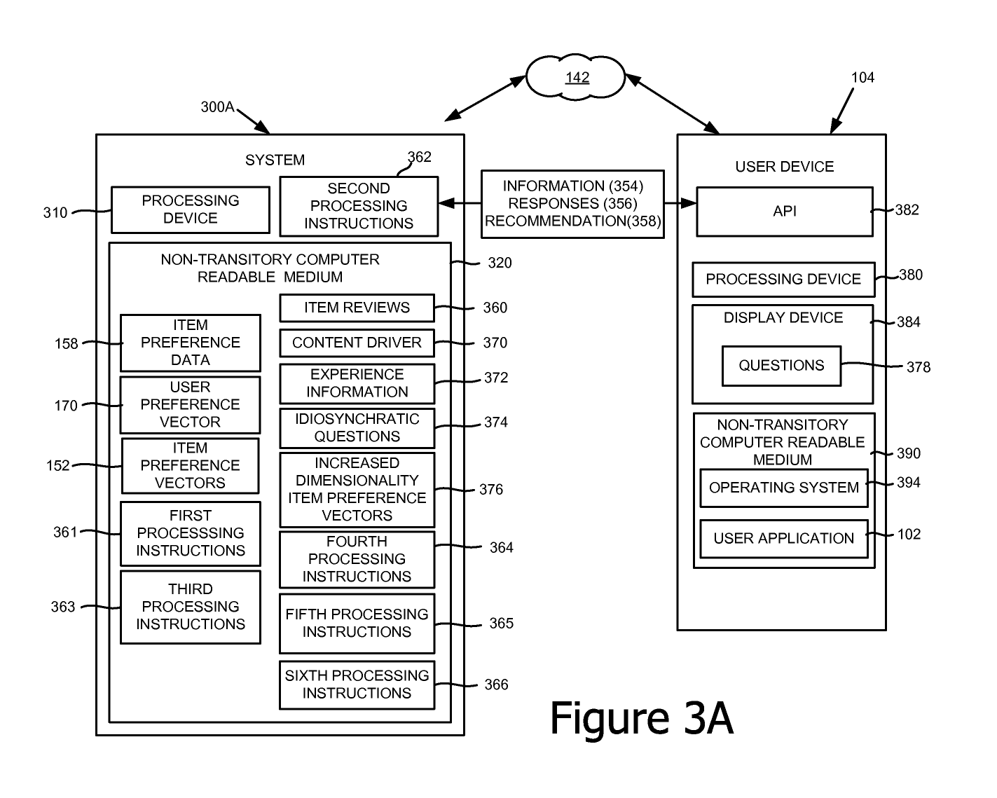

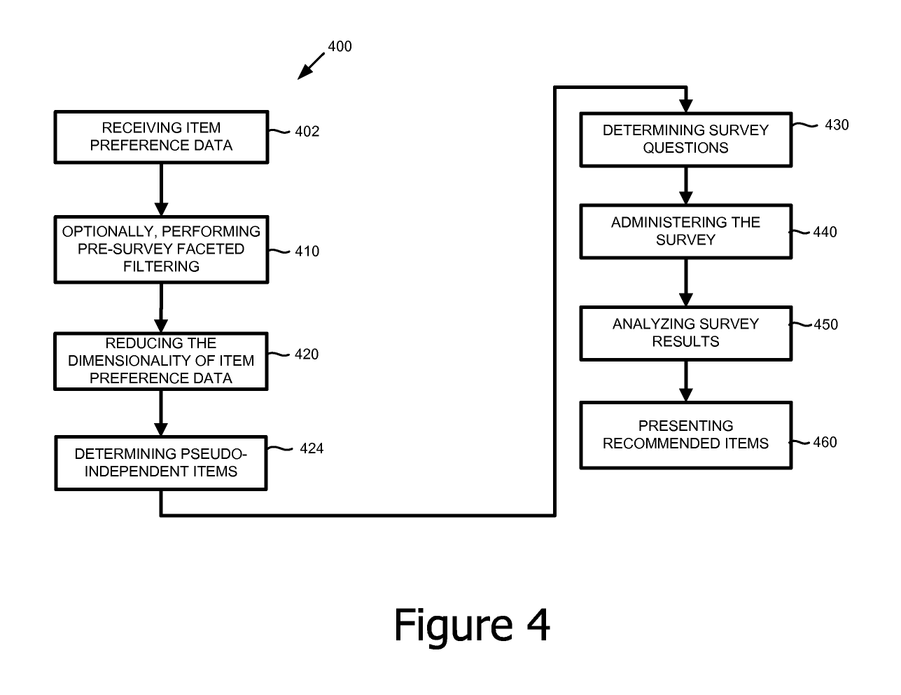

FIG. 3 is a block diagram of an embodiment of an information elicitation system according with the disclosure. In the present embodiment, the system is denoted by numeral 300. System 300 comprises a processing device 310, API 132 and a non-transitory computer readable medium, or memory, 320. Memory 320 has embedded therein item preference data 158 and a plurality of processing sequences, including a dimensionality reduction processing sequence 332, a facet processing sequence 336, a survey candidates processing sequence 340, a survey processing sequence 344, a recommendation processing sequence 348 and a recommendation presentation processing sequence 352. Dimensionality reduction processing sequence 332 may process the item preference data by computing principal components, transposing matrices, computing sum-products and generating a feature matrix, as explained with reference to FIG. 4. Reduced dimensionality preference simulation application 136 may include dimensionality reduction processing sequence 332. Facet processing sequence 336 receives facet data from users and applies the facet data to filter item preference data or recommendations. Survey candidates processing sequence 340 takes the output from dimensionality reduction processing sequence 332 or facet processing sequence 336 and identifies items for inclusion in survey questions. Survey processing sequence 344 takes the items and presents them as questions, receives survey information from users, uses the information to replace or select items in the questions and outputs a list of selected items. Exemplary survey information includes responses, veto commands and switch-out commands. Recommendation processing sequence 348 generates item scores based on the selected items and the feature matrix. Recommendation presentation processing sequence 352 presents the recommended items to the user based on the scores.

In one variation, system 300 includes a veto feature to make the system easier to use. In the present embodiment, recommendation presentation processing sequence 352 presents the recommended items to the user and also presents control buttons for vetoing a recommendation. The user vetoes one item after another until only one item remains. In another variation, the system is used by a group of users to arrive at a group recommendation. Recommendation presentation processing sequence 352 presents the recommended items to the users in order. After a user vetoes an item, a subsequent user is presented the recommendation list, less the vetoed item(s). The subsequent user vetoes another item by activating the control button. The veto process may continue until only one recommended item remains. In one example, after each of the users vetoed an item, recommendation presentation processing sequence 352 reverses the user order such that the last user to veto an item in one round of vetoing becomes the first user to veto an item in the subsequent round.

Also embedded in memory 320 are one or more operating systems and software applications operable to cause API 132 to establish communications with another system or device, for example user device 104. In one variation, system 300 comprises a server system. In another variation, system 300 comprises a user device. Exemplary user devices include personal computers, portable computers, an IPAD™, IPHONE™ or BLACKBERRY™ mobile device, a set-top box, a smart TV, a digital video disc player, a kiosk, and any device including a processing device, memory and an I/O interface operable to receive user commands and establish communications with other systems or devices. Generally, a set-top box, a smart TV, a digital video disc player, and a kiosk connect to the internet and to a television. A remote control associated with the set-top box, smart TV, digital video disc player, or kiosk is operable to access the internet and download media from remote services.

Also shown in FIG. 3 are user device 104 connected to recommendation system 300 through information network 142. Exemplary information networks include the Internet, WiFi wireless networks, cellular communication networks, and any communications system suitable to transfer information digitally between two systems or devices. User device 104 comprises a processing device 380, API 382, a display device 384 and a non-transitory computer readable medium, or memory, 390. Memory 390 has, embedded therein, an operating system 394 and user application 102. Operating system 394 is operable to cause processing device 380 to establish communications with system 300, and also to receive user commands or instructions or input via one or more user input devices including a keyboard, a mouse, a touch-screen and a voice-command driven input device.

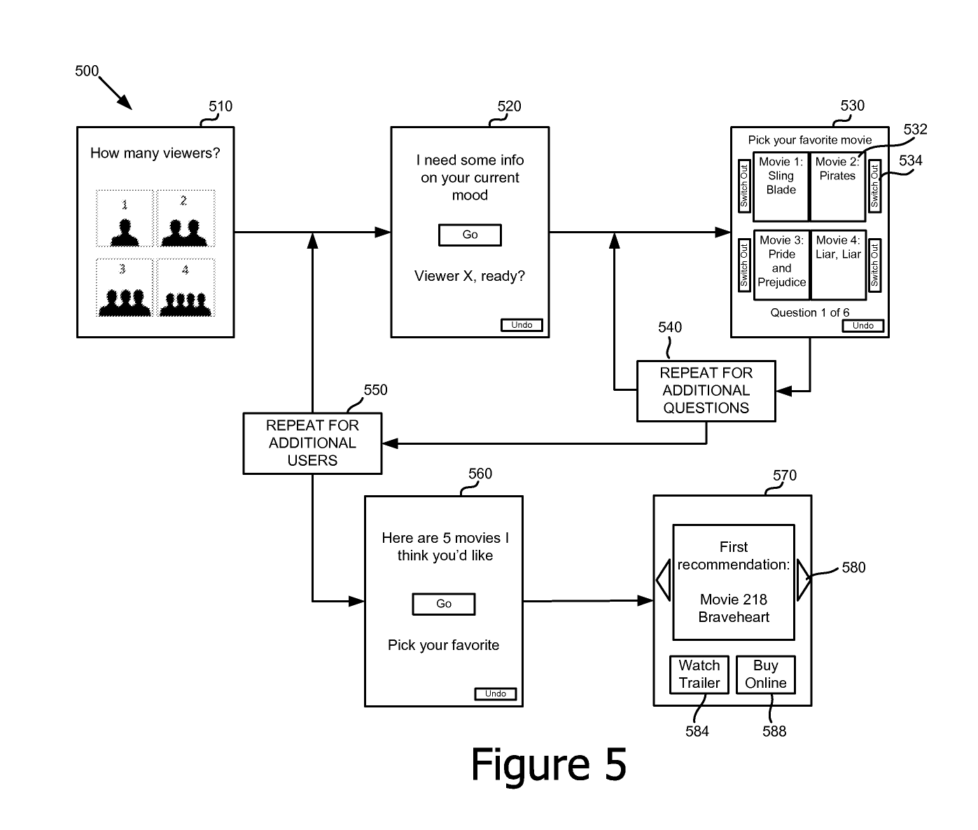

API 132 and API 382 are operable to share information between system 300 and user device 104. API 132 and API 382 transfer survey information 314 and recommendation information 316. Recommendation information 316 includes the user's inputs pertaining to the selection or rejection of an item. Selection or rejection is described with reference to FIG. 5.

FIG. 3A is a block diagram of another embodiment of an information elicitation system according with the disclosure. In the present embodiment, the system is denoted by numeral 300A. System 300A includes processing device 310, one or more non-transitory computer readable medium 320; and processing instructions embedded in the non-transitory computer readable medium, the processing instructions configured to elicit information from the user when processed by the processing device. The processing instructions include first processing instructions 361, second processing instructions 362, third processing instructions 363, fourth processing instructions 364, fifth processing instructions 365, and sixth processing instructions 366. First processing instructions 361 are configured for reducing the dimensionality of item preference data 158 corresponding to items 194 and identifying pseudo-independent items 154, from the items, based on the reduced dimensionality item preference data. The reduced dimensionality item preference data comprises item preference vectors 152. Second processing instructions 362 are configured for outputting information 354 for presenting questions 378 and receiving responses 356, the questions based on the pseudo-independent items to elicit explicit pseudo independent items relative information from the user. Survey information 314 may include information 354, responses 356, experience information 372, idiosyncratic questions 374 and questions 378. Survey information 314 may be used to generate content drivers 370 which can be used to filter items and to bias the responses in favor of, for example, types of users.

In one example, the system includes API 132, which includes the second processing instructions.

In another example, the system includes a user device application 102 operable to present questions 378 and output responses 356.

In one variation, third processing instructions are configured for generating second item preference data for additional items and performing a regression computation based on the second item preference data to fold-in the additional items into the item preference data.

In another variation, fourth processing instructions 364 are configured to generate third item preference data from responses from respondents, the third item preference data being different than the item preference data, wherein the regression computation is based on the second item preference data and the third item preference data.

In yet another variation, fifth processing instructions 365 are configured for receiving item reviews 360 from reviewers and identifying from the reviewers those reviewers whose preferences are similar to the user's preferences, wherein the second processing instructions are further configured for outputting an item recommendation including a recommended item and the item reviews received from the identified reviewers and relating to the recommended item.

In a further variation, sixth processing sequence 366 is configured for appending content driver 370 to item preference vectors 152 to generate increased dimensionality item preference vectors 376.

Item preference data 158 comprises one or more data structures, each relating a list of items to corresponding respondent data. To obtain item preference data 158, a plurality of respondents provide preference information in connection with the items in a list to calibrate the system. An initial calibration may be enhanced with subsequent calibrations to incorporate information about new items in the item preference data 158. An initial calibration will be described with reference to movies. The same process is applicable to other items. In the initial calibration, a number of respondents rank-order a set of commonly watched movies. Ideally, all the respondents have watched all the movies. If all the respondents rate all the items, the dataset may be referred to as a “dense dataset”. For example, a set of 100 commonly watched movies would be compiled and presented to a set of 50 respondents. Each respondent rank-orders the movies from 1 to 100. In one example, images of two movies are presented to the respondent, and the respondent chooses the movie he prefers. The process is repeated until, by comparing movies to other movies, the 100 movies are rank ordered. As described below, the rank-ordered responses are transformed so that they exhibit a uniform or normal distribution. Other distributions are also suitable.

The item preference data data structure comprises an array of items and respondent data. In one example, items are listed in rows and respondent data is listed in columns. The intersection of each row and column includes the data for the corresponding respondent (column) and item (row). In one variation, each respondent ranks all the items in the list, and the ranked data is transformed so that it is uniformly distributed with a mean equal zero and a range between −0.5 and 0.5. An exemplary portion of item preference data comprising four movies and six respondents is shown in Table 2.

TABLE 2

| Items/Re- | | | | | | | |
|---|---|---|---|---|---|---|---|
| spondents | R1 | R2 | R3 | R4 | R5 | R6 | . . . |
| Mars | (0.3422) | 0.1078 | (0.5838) | 0.2119 | (0.4375) | (0.0936) | . . . |
| Attacks! | | | | | | | |
| Juno | (0.4572) | 0.2824 | 0.1320 | 0.0108 | 0.3371 | 0.2869 | . . . |
| Braveheart | 0.2095 | 0.3106 | 0.3981 | 0.2805 | 0.0738 | 0.4090 | . . . |
| A Beauti- | (0.4020) | 0.3313 | 0.3526 | 0.2122 | (0.2128) | 0.3256 | . . . |
| ful Mind | | | | | | | |
| . . . | . . . | . . . | . . . | . . . | . . . | . . . | . . . |

Item preference data may further include facet information. The facet information is used to filter items. Therefore, the facet information relates to desired filtering. Exemplary movie facets include movie length, release date, rating, availability by service, genre, and any other characteristic suitable to categorize movies. Movie ratings include ratings from Common Sense Media, Inc., critics.com, Motion Picture Association of America, Inc., Film Advisory Board, Inc., and any other organization or individual based on the content of the rated movie. Movie ratings also include other rating mechanisms such as most viewed, release week gross sales and the like. Furthermore, item preference data may include an indicator indicating whether a respondent or user has watched the movie. Exemplary service provider facets include distance from current location, venue type, cost, rating and the like. For example, a user may be willing to drive 30 miles to eat at a highly rated but not expensive Chinese restaurant. With the appropriate system, including facet information, the user can choose the appropriate facets to receive recommendations meeting the criteria.

Assumptions may be used to substitute missing information. For example, if a respondent or user does not provide a response relative to an item, it may be assumed that the respondent is indifferent to the item. However, the density of the dataset (and the accuracy of the results based on it) decreases as the number of substitutions increases. An alternative approach is to fold-in new items, respondents and users into the existing dataset. Generally, folding-in is a process by which new items and users are calibrated to the existing dataset based on a reduced number of survey questions used to identify a corresponding vector. An embodiment of a fold-in method is described below.

Embodiments of the method disclosed herein can be implemented using a variety of dimensionality reduction techniques. Dimensionality reduction techniques are used to reduce the dimensionality, or complexity, of data without losing significant information. The techniques, in general, identify patterns in the data and characterize the information in the data based on the patterns. Less important patterns are removed or ignored, thereby reducing dimensionality without discarding significant information. One known technique is principal component analysis (“PCA”). PCA is mathematically defined as an orthogonal linear transformation of data to a new coordinate system such that the greatest variance by any projection of the data lies on the first coordinate (called the first principal component), the second greatest variance on the second coordinate (called the second principal component), and so on.

The data, referred herein as item based data or item preference data, comprises information obtained from respondents concerning items. As described above, the item preference data is obtained in a system calibration and, optionally, in subsequent calibrations. The item preference data is organized in a m×n matrix comprising M items data generated from information provided by each of N respondents. An exemplary portion of an item preference data matrix was presented above in Table 2. The mean user score is subtracted for each score. A matrix X results which has a zero empirical mean and is mathematically expressed as:

X={X[m,n]};m=1 . . . M;n=1 . . . N

The goal is to transform a given data set X of dimension M to an alternative data set of smaller dimension.

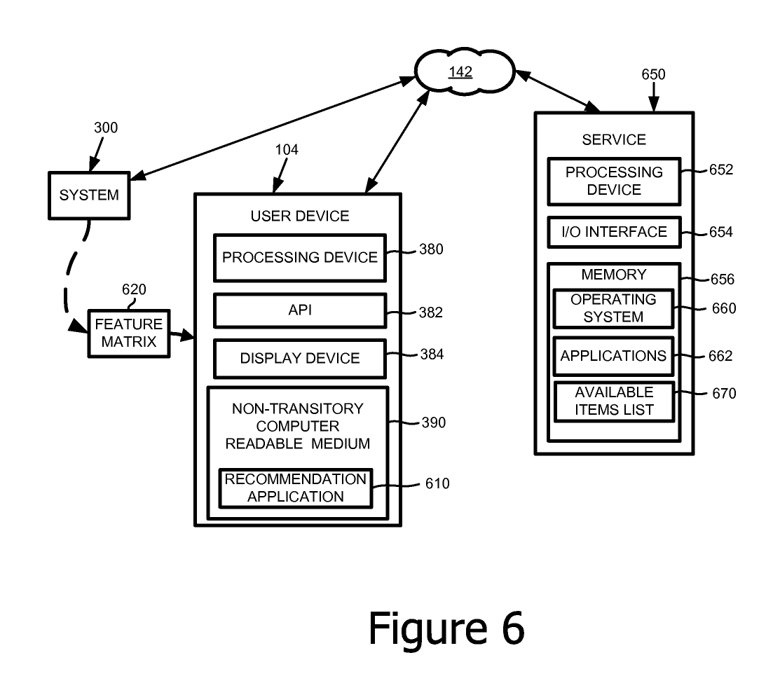

FIG. 4 is a flowchart 400 of an embodiment of a method according with the disclosure for recommending items. At 402, the method begins with receiving item preference data. Item preference data comprises an array of items and corresponding respondent information and can be received in any form, including user input and a data structure such as a file. In one variation described with reference to FIG. 6, the system receives item preference data and then transfers the item preference data or a feature matrix to a user device, in the same or a different data format. Item preference data includes a sufficient number of items to permit computation of preference drivers, e.g. principal components. An exemplary portion of item preference data was presented in Table 2.

Optionally, processing continues at 410 with performing pre-survey facet filtering. Facet filtering comprises selection of a facet and filtering items according to the facet. Exemplary filtering includes inclusive and exclusive filtering. After filtering, a reduced number of items are available for further processing. In one example, facet filtering is applied to the item preference data, therefore a reduced number of items is available in the item preference data for computation of principal components. In another example, facet filtering is applied subsequent to the computation of principal components. In a further example, facet filtering is applied to a feature matrix before selection of potential question candidates. Computation of the feature matrix is described below. Exemplary GUI windows configured to select facets are described with reference to FIGS. 12 and 13.

At 420, the process continues with reducing the dimensionality of item preference data. Reducing item preference data dimensions involves different steps depending on the form of the item preference data. In one example, respondent information is normally distributed and centered, and processing continues to the computation of principal components. In another example, item preference data comprises rank data which is first normalized by a Cox-Box transformation to transform the ranked data to normally distributed data with a mean of 0.0. In one example, the normal data is scaled to have a standard deviation equal to about 1.0. to simplify matrix computations. Of course, the Cox-Box transformation can also be used to scale the item preference data. In a further example, respondent information is uniformly distributed with a range equal to about 1.0 and centered, and processing continues to the computation of principal components. As described above, a number of techniques are known for determining principal components to enable dimensionality reduction.

In one example, principal component analysis is performed to identify the principal components. First, a matrix Y of dimension N is computed as the Karhunen-Loève transform (KLT) of matrix X. A number of PCA computational methods are known, including the covariance, matrix factorization and singular value decomposition methods. A notable characteristic of dimensionality reduction techniques is that the principal components are determined analytically based on the respondent's input as opposed to being predetermined. Matrix Y comprises N rows (respondents) and N columns (principal components, e.i. PC1 to PCN). The principal components (eigenvectors) are ordered from left to right in order of importance. The elements of the matrix are referred to as the principal component loadings and may be referred to herein as the item attributes. An exemplary portion of a matrix Y computed from item preference data presented in Table 2 is shown in Table 3. As described previously, the number of items and respondents may be large. The number of items may exceed one-hundred and the number of respondents may exceed fifteen. Only six respondents and principal components, and four movies (items), are shown in Tables 3-5 to simply the illustrations, while ellipsis are shown to indicate that additional matrix elements exist.

TABLE 3

| Respon- | | | | | | | |
|---|---|---|---|---|---|---|---|
| dents/PCs | PC1 | PC2 | PC3 | PC4 | PC5 | PC6 | . . . |
| R1 | 0.0431 | 0.0487 | (0.1789) | 0.0585 | (0.3461) | 0.0037 | . . . |
| R2 | 0.3047 | (0.2157) | (0.0391) | 0.2007 | 0.1479 | 0.3203 | . . . |
| R3 | 0.1195 | 0.1093 | (0.4166) | 0.1108 | (0.3275) | 0.1793 | . . . |
| R4 | 0.2931 | 0.0184 | (0.0552) | 0.2662 | 0.0515 | 0.0500 | . . . |
| R5 | 0.1345 | 0.1527 | (0.4742) | 0.1721 | (0.1118) | (0.2856) | . . . |
| R6 | 0.2976 | (0.1024) | (0.4463) | (0.7530) | 0.0552 | 0.1832 | . . . |
| . . . | . . . | . . . | . . . | . . . | . . . | . . . | . . . |

The next step is to transpose matrix Y and apply the principal component loadings to the items. This is accomplished by calculating the sum-products of transpose Y and matrix X to obtain a matrix Z, in which

$${z}_{11} = \sum ( {y}_{11} * {x}_{11} + {y}_{12} * {x}_{12} … + {y}_{1 N} * {x}_{1 N} )$$

$${z}_{21} = \sum ( {y}_{11} * {x}_{21} + {y}_{12} * {x}_{22} … + {y}_{1 N} * {x}_{2 N} )$$

$$⋮ ⋮$$

$${z}_{12} = \sum ( {y}_{21} * {x}_{11} + {x}_{22} * {x}_{12} … + {y}_{2 N} * {x}_{1 N} )$$

$${z}_{22} = \sum ( {y}_{21} * {x}_{21} + {y}_{22} * {x}_{22} … + {y}_{2 N} * {x}_{2 N} )$$

$$⋮ ⋮$$

$${z}_{mn} = \sum ( {y}_{N 1} * {x}_{M 1} + {y}_{N 2} * {x}_{M 2} … + {y}_{NN} * {x}_{MN} )$$

Alternatively, matrix Z is obtained by multiplying matrices X and Y. Matrix functions, including multiplication and principal component analysis, are available in MatLab™ software available from MathWorks, Inc. Principal component analysis can also be computed with GNU Octave software, available for download from ftp://ftp.gnu.org/gnu/octave.

Therefore, each element of matrix Z represents the degree to which each principal component is present in each item, based on the information from all the respondents. The elements in a row represent an item vector and may be referred to herein as item attributes. An exemplary portion of a transpose Y and matrix Z computed from item preference data presented in Table 2 is shown in Tables 4 and 5.

TABLE 4
transpose Y:

| PCs/ | | | | | | | |
|---|---|---|---|---|---|---|---|
| Respon- | | | | | | | |
| dents | R1 | R2 | R3 | R4 | R5 | R6 | . . . |
| PC1 | 0.0431 | 0.3047 | 0.1195 | 0.2931 | 0.1345 | 0.2976 | . . . |
| PC2 | 0.0487 | (0.2157) | 0.1093 | 0.0184 | 0.1527 | (0.1024) | . . . |
| PC3 | (0.1789) | (0.0391) | (0.4166) | (0.0552) | (0.4742) | (0.4463) | |
| PC4 | 0.0585 | 0.2007 | 0.1108 | 0.2662 | 0.1721 | (0.7530) | . . . |
| PC5 | (0.3461) | 0.1479 | (0.3275) | 0.0515 | (0.1118) | 0.0552 | . . . |
| PC6 | 0.0037 | 0.3203 | 0.1793 | 0.0500 | (0.2856) | 0.1832 | . . . |
| . . . | . . . | . . . | . . . | . . . | . . . | . . . | . . . |

TABLE 5
matrix Z:

| Items/PCs | PC1 | PC2 | PC3 | PC4 | PC5 | PC6 | . . . |
|---|---|---|---|---|---|---|---|
| Mars | 0.2918 | 0.0393 | 0.8880 | (0.2983) | 0.2077 | (0.4644) | . . . |
| Attacks! | | | | | | | |
| Juno | (0.1579) | (0.5288) | (0.7011) | 0.0809 | 0.2703 | 0.1372 | . . . |
| Braveheart | 0.1401 | 0.4475 | (0.5603) | (0.2486) | 0.2158 | 0.3543 | |
| A Beauti- | (0.1973) | (0.5897) | (0.5329) | 0.0492 | 0.3164 | 0.3113 | . . . |
| ful Mind | | | | | | | |
| . . . | . . . | . . . | . . . | . . . | . . . | . . . | . . . |

The next step is the selection of an arbitrary number of principal components to form a feature matrix. As described below, more or fewer principal components are selected to form the feature matrix. For simplicity, the feature matrix will be described as having four principal components, the four left-most principal components of matrix Z, also described as principal components A, B, C and D. An exemplary feature matrix is shown in Table 6, illustrating reduction of the dimensionality of matrix Z. Above each column, the standard deviation for the attributes in the column is shown, i.e. 0.3329, 0.1532, etc.

TABLE 6
feature matrix:

| Standard Deviation | 0.3329 | 0.1532 | 0.1121 | 0.0987 |
|---|---|---|---|---|
| | PCs | | | |
| Items | PC1 | PC2 | PC3 | PC4 |
| Mars Attacks! | 0.2918 | 0.0393 | 0.8880 | (0.2983) |
| Juno | (0.1579) | (0.5288) | (0.7011) | 0.0809 |
| Braveheart | 0.1401 | 0.4475 | (0.5603) | (0.2486) |
| A Beautiful Mind | (0.1973) | (0.5897) | (0.5329) | 0.0492 |
| . . . | . . . | . . . | . . . | . . . |

Reduced dimensionality preference simulation application 136 may perform the method steps to generate the feature matrix. Reduced dimensionality preference simulation application 136 may then perform simulations, as described further below, based on the feature matrix. Reduced dimensionality preference simulation application 136 may receive user preference information to perform the simulation by implementing the following method steps, or may receive preference information by any other known methods. User preference information may be stored in database 140.

The present method embodiment continues, at 424, with determining the pseudo-independent items for inclusion as survey candidates. Pseudo-independent items may be selected by evaluating the feature matrix values to identify the items with the largest positive and negative attributes for a single principal component and with small attributes for the remaining principal components are selected. As seen in Table 6, the attribute corresponding to PC3 and the movie Mars Attacks! equals 0.8880 while the remaining attributes for the movie are less than 0.3; therefore, the movie Mars Attacks! is a positive question candidate for a question requiring PC3 (or C). The pseudo-independent items may also be determined as described with reference to FIG. 2. The pseudo-independent items may be selected from pools of pseudo-independent items in random or predetermined order.

Having determined the pseudo-independent items, the method continues, at 430, with determining survey questions. The survey questions may be posed as a choice between pseudo-independent items. Thus, for one principal component, two items are selected for the questions. For two principal components, four items are selected. Requiring a user to choose one of four items effectively addresses the relative importance of each principal component. In the present embodiment, four principal components are used to determine a user's current preferences by asking only six questions. The first question requires the user to choose an item from a set of items exhibiting preferences A+, A−, B+ and B−. Subsequent questions pair principal components A/C, A/D, B/C, B/D and C/D, each possible pair of principal components defining a question. The method essentially identifies an orthogonal set of items. The degree to which orthogonality is preserved depends on whether items correlated to a single principal component can be found. However, even without complete orthogonality the method described herein enables a recommendation of items to be made to a user matching the user's current mood, represented by the answers to the six questions. The degree of orthogonality can be defined in a computational step.

The present method embodiment continues, at 440, with administering the survey. As explained before, four items are presented, which are selected based on paired principal components, positive and negative. The user is required to choose one of the four items. After choosing one item, the next question is presented, until all the questions have been presented. In one variation, the user is given the choice to exclude or switch-out an item from a question. For example, the user may not be familiar with an item in the question. If an item is rejected, the item is replaced with another candidate from the pool of potential question candidates. Selection and rejection are described in more detail with reference to FIG. 5.

The present embodiment of the method continues, at 450, with analyzing survey results to determine the user's preference vector. In the case where four principal components are used, there are six chosen items and eighteen rejected items, therefore, there are twenty four item vectors representing the current mood of the user. In one variation, the attributes of the six vectors corresponding to the six chosen items are averaged to generate the preference vector. In one example, the preference vector is weighed with the attributes of the rejected items. In another example, the average of the vectors corresponding to the not chosen items is subtracted from the average of the vectors corresponding to the chosen items.

The recommendation method and system described herein is not limited by the form of the survey. While a multiple-choice survey has been described hereinabove, other inquiry forms are suitable for obtaining question responses from users relative to pseudo-independent items. In one variation, the method comprises asking each user to rank-order a limited number of items. In another variation, the users answer whether they like or dislike items. The question responses are then analyzed to define user preference vectors utilizing any computational method, including those described above.

Having determined the user's preference vector based on the survey, the next step is to generate item scores. The items are then ranked according to the scores. The items with the highest scores are the recommended items. In one example, the sum-product of the preference vector and the feature matrix generates the item scores. In another example, the feature matrix is multiplied by the preference vector to generate the item scores. In one example, faceted filtering is applied to filter out items from a potential recommendation list.

The present method embodiment continues, at 460, with presenting recommended items. In one variation, a list of recommended items is presented. In another variation, the top item is presented along with “next” and “last” icons for presenting previously presented (last) and the next recommended item (next).

FIG. 5 is a flowchart 500 of an embodiment of a general recommendation method according with the disclosure for navigating the recommendation system and selecting items. A GUI embedded in memory comprises instructions for presenting visual representations of questions and control icons, and receiving user information. Visual representations comprise a user selection screen 510, a survey initiation screen 520, a survey question screen 530, a recommendation process screen 560 and an item recommendation screen 570. In one variation, the GUI is embedded in a system, e.g. system 130 or 300, and the visual representations are visible in a user device functioning as a web client. In another variation, the GUI is included in a recommendation application operable in a user device, such as the recommendation application 610 described below with reference to FIG. 6.

The method begins after the user activates the GUI, at which time user selection screen 510 is presented by the GUI. The GUI receives a user input indicating how many users will participate in the recommendation process. Then, the GUI presents survey initiation screen 520 to indicate to the user that information is required to assess the current mood of the user. The screen also displays a user number, shown as “X”, to indicate which of the number of users should next provide mood information. If one user has been selected, then X=1. If four users have been selected, then X will comprise 1, 2, 3 or 4 depending on how many surveys have already been completed. In one variation, each user accesses the user device, in turn, to complete the survey. In another variation, users log into the system and take the surveys with different personal devices.

Survey question screen 530 is presented next showing four item images 532, i.e. movies. Switch-out buttons 534 enable the user to switch-out the item located next to each button 534. One of the items must be selected to proceed. An item may be selected by touch in the case of touch-screens, with a mouse pointer or with any other user interface. After the item is selected, at 540, the process is repeated for as many survey questions as are coded in the system. After the last question is answered, at 550, the process is repeated for as many users as were selected with user selection screen 510. The value of X is incremented accordingly, until the last user survey has been completed.

The method continues with presentation by the GUI of recommendation process screen 560. After the user indicates desire to view the recommendations, i.e. activating a “go” control button, item recommendation screen 570 is presented showing the first recommendation. Navigation buttons 580 are presented to navigate to the previous or next item recommendation. In the present embodiment, a “watch trailer” button 584 is provided to enable the user to preview the recommended movie. A button 588 is provided to enable the user to order the movie from an online service provider. A system API communicates with an API of the service to authenticate the user's account and authorize the transaction. The user may authenticate the account at any time prior to ordering an item. In a variation of the present embodiment, the user logs into the system of the service provider and the recommendation system API automatically downloads movie availability information from the service provider. In one example, the recommendation system limits recommendations to available movies.

FIG. 6 is a block diagram of another embodiment of a recommendation system according with the disclosure. The system comprises system 300 and a recommendation application 610. Recommendation application 610 is stored in the memory of a user device and comprises a GUI operable to administer a survey and present recommendations. User device 104, including non-transitory computer readable medium, or memory 390, is shown. As described above, exemplary user devices include personal computers, portable computers, an IPAD™, IPHONE™ or BLACKBERRY™ mobile device, a set-top box, a smart TV, a digital video disc player, a kiosk, and any device including a processing device, memory and an I/O interface operable to receive user commands and establish communications with other systems or devices. A dashed line illustrates the transfer of a feature matrix 620 from system 300 to user device 104. The transfer occurs through information network 142 and is shown separately for clarity.

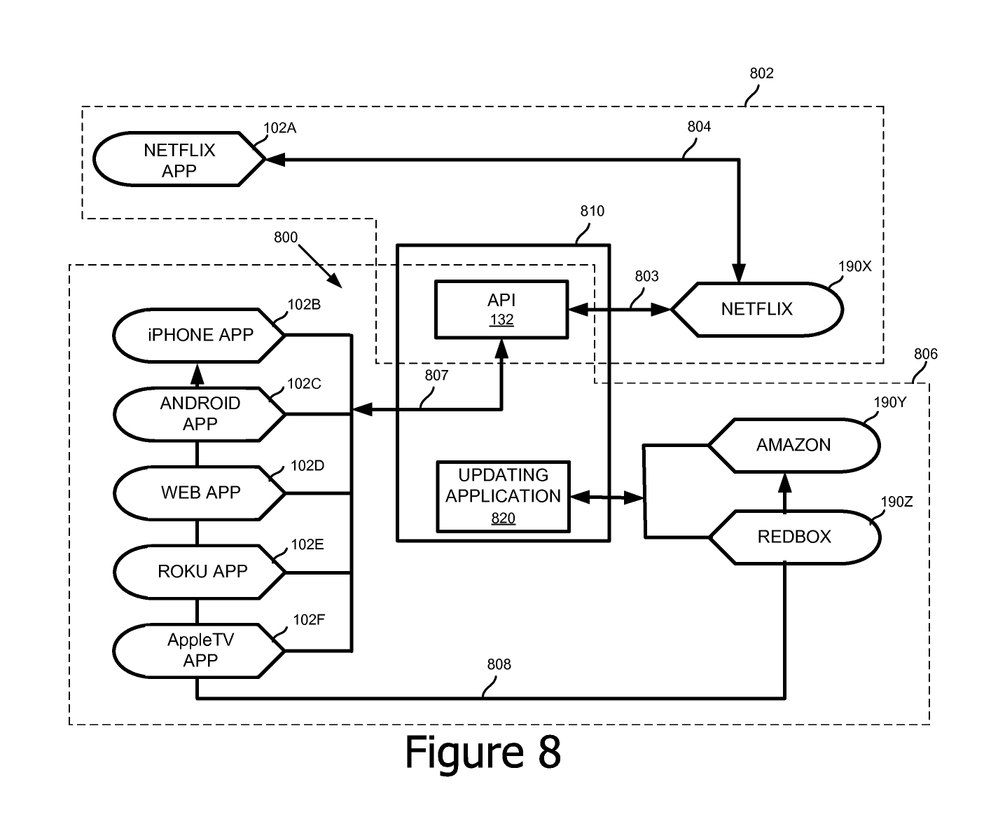

Also shown in FIG. 6 is a service 650, e.g. a movie delivery service, connected to the recommendation system through information network 142. Service 650 comprises a processing device 652, an I/O interface 654, and a memory 656. Memory 656 has embedded therein an operating system 660, applications 662, and an available items list 670. An exemplary application is an API for delivering available items list 670 to either system 300 or user device 104. In one variation, all communications concerning the recommendation system, except those in connection with login, authentication and payment, flow between user device 104 and system 300, and between system 300 and service 650. In other words, user device 104 communicates through system 300 to service 650. In another variation, user device 104 communicates directly with service 650, and service 650 updates system 300 with respect to movie transactions and compensation based on items ordered using the recommendation system. System 130 is equivalent to, and interchangeable with, system 300. Exemplary business processes in which a service, or online vendor, communicates with system 300 and a user device application such as recommendation application 610 is described with reference to FIG. 8.

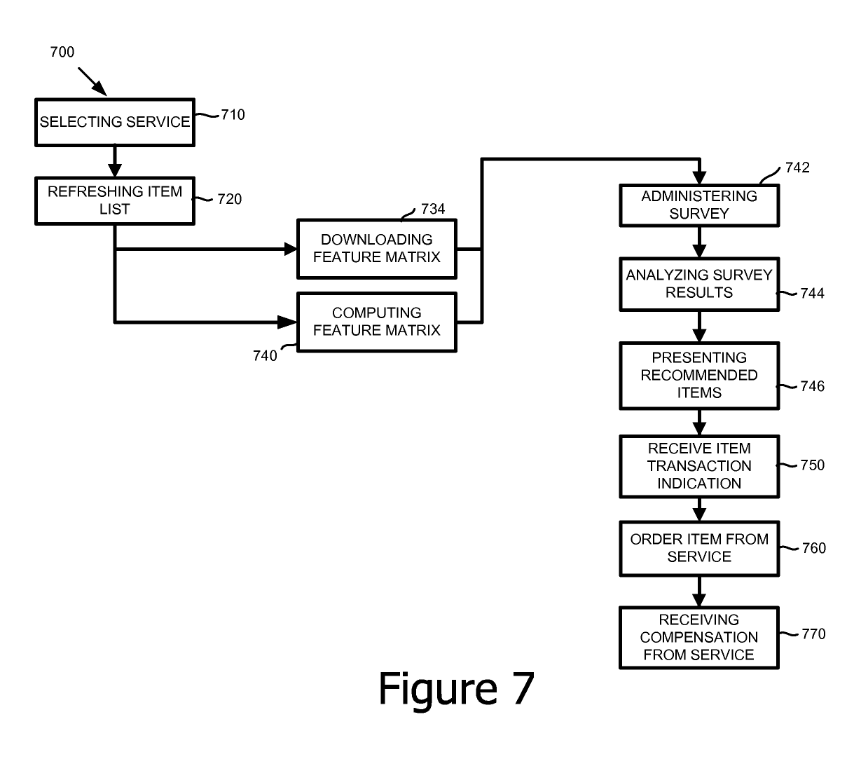

FIG. 7 is a flowchart 700 of another embodiment of a method according with the disclosure in which the recommendation system provides information to a user device, and the user device performs some of the item preference or feature matrix processing. The method may be implemented with the system described with reference to FIG. 6. The method begins, at 710, with selection of a service. In one example, the GUI presents the user with a number of service options (e.g. as shown on FIG. 8) and the user activates a control button to choose one of the services. At 720, the service refreshes the item list stored in the user device. The item list may include additional information operable for facet filtering. In one variation, system 300 computes and pushes the feature matrix and, at 734, the feature matrix is downloaded by the application. In one example, system 300 also pushes item images for the survey questions. In another example, system 300 receives the available items list and pushes a feature matrix based on the available items. Once the recommendation application in the user device has a feature matrix, the application may run without internet access. In another variation, the recommendation application in the user device is operable, at 740, to download item preference data from system 300 and compute the feature matrix.

After the recommendation application has the feature matrix, the GUI, at 742, administers the survey. At 744, the application administers and analyzes the survey results and, at 746, presents recommended items, in the manner previously described with reference to FIG. 5. In one example, the administration, analysis and presentation functions are performed by processing sequences such as survey processing sequence 344, recommendation processing sequence 348 and recommendation presentation processing sequence 352. In one example, presentation includes providing users control buttons with which to veto items, as described previously with reference to recommendation presentation processing sequence 352. In one variation of the present embodiment, the recommendation application downloads the survey questions from system 300 and uploads the survey results to system 300. System 300 analyzes the survey results and then provides the recommendations to the application.

At 750, the application receives an item transaction indication. An exemplary transaction indication is a user command to order a movie. The user may order the movie by activating the appropriate control button, such as control button 588 described previously with reference to FIG. 5. At 760, the recommendation application orders the selected item from the service. Then, at 770, the service provides compensation to system 300. In one example, the order includes a token referencing the recommendation system, which enables the service to compensate system 300 with payment equal to a portion of the transaction or a fixed amount.

FIG. 8 is a block diagram of an implementation of system 800 configured to enable a plurality of user device applications, exemplified as user applications 102A-F, to engage in transactions with various services, or online vendors, exemplified as web servers 190X-Z. System 800 includes a system 810 including API 132 and an updating application 820. System 810 may be configured as system 130 or 300 to implement any of the methods described above. FIG. 8 also illustrates two business processes enclosed in dashed lines and denoted by numerals 802 and 806. Both business processes rely on API 132 administer surveys and generate recommendations.

In business process 802, lines 803 and 804 represent communication lines (copper lines or wireless lines or both) between web server 190X and API 132, and between web server 190X and application 102A. Web server 190X and application 102A are online vendor components, illustratively a Netflix server and a Netflix application. The online vendor develops and implements its servers and applications as it desires, and accesses API 132 to administer surveys to users of its applications and to receive recommendations which the online vendor then provides to its applications. The applications include mobile applications and also web pages. System 810 includes the necessary databases and applications to receive survey requests and output survey questions via API 132, to process the survey information provided by the online vendor, and to output the recommendations, also via API 132. In essence, system 810 is a recommendation server, and the online vendor is a recommendation client.

In business process 806, line 807 represents communication lines (copper lines or wireless lines or both) between API 132 and applications 102B-F. Line 808 represents communication lines (copper lines or wireless lines or both) between web servers 190Y and 190Z and applications 102B-F, illustratively online vendors Amazon and Redbox. The online vendors communicate with updating application 820 to provide lists of current offerings, such as available movies. Updating application 820 updates the recommendation system databases with the up-to-date items. An application program (not shown), illustratively application program 134, accesses API 132 to administer surveys to users of applications 102B-F and to send recommendations to applications 102B-F, also via API 132. In the present example, applications 102B-F are the recommendation clients. Applications 102B-F may then access web servers 190Y and 190Z via line 808 to request a movie preview or enter into an online transaction with the online vendors.

Rental movies can typically be rented from a service at a low cost. The rental cost may, in fact, be the same for most movies. Even when prices differ, for example between regular and high definition movies, the price difference does not generally drive the user's preferences. Other items, however, are very price sensitive. Clothing, fragrance and jewelry items, athletic equipment, restaurants, vacations and other expensive items, for example, can differ significantly in price. In the embodiments described below, user preference vectors are used to recommend prices, make recommendations that incorporate pricing as a driver or provide simulated pricing information. These recommendations and information enable merchants to adjust pricing to increase sales volume, increase profits and adjust inventories by tailoring pricing to use preferences on individual and group basis.

In one embodiment, preference-price efficient items are recommended. Preference-price efficient items are the most preferred items at given prices or in given price ranges. Thus, instead of recommending the top five items employing the methodologies described above with reference to movies, in the present embodiment price-sensitive methodologies are applied to identify the items which are most preferred within given price ranges. In one example, if a given price-point is $100, the most preferred items priced at or below $100 are recommended. In another example, a plurality of price-points are given, and the most preferred items priced at or below each given price-point are recommended. If the given price-points are $150, $100 and $50, the recommendation may include, for example, three items priced at or below $150, three items priced at or below $100, and three items priced at or below $50. The recommendations are based on the user's preference vector. The given price-points are arbitrary and can be set based on the type of item being recommended and the user's characteristics.

In a variation of the present embodiment, only items that are preferred to every item with a lower price are included in the recommendation. As described below, inefficient items (those items excluded from the recommendation due to their price) can be discounted so that they become preferred to every lower priced item. Inefficient items present discounting opportunities. Known forecasting techniques can be used to predict how many potential buyers would purchase the item at the discounted price versus the initial price. For example, a merchant may offer coupons to selected customers or temporarily test a discounted price on a website to assess its impact. Customers may also be selected for testing a discounted price based on their characteristics after matching their characteristics with the preference vector used to compute the discounts.

In another embodiment, preference vectors of respondents or users are correlated to individual characteristics, and discounts computed as described above are provided to potential buyers matching the individual characteristics. The individual characteristics may include demographic, purchase history, and other individual characteristics.

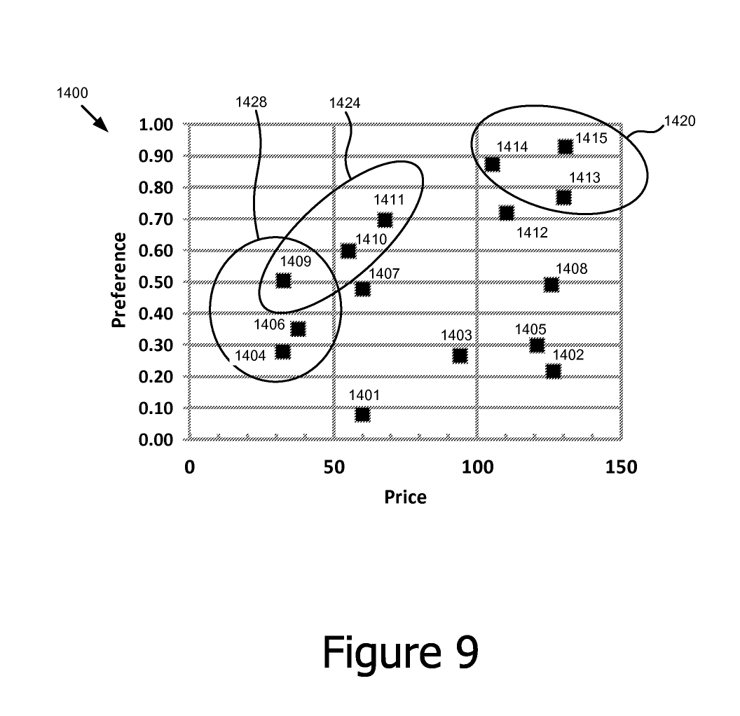

The present embodiment will now be described with reference to FIG. 9, in which a graph 1400 is presented to illustrate the selection of preference-price efficient items. On graph 1400, fifteen preference/price points are shown corresponding to fifteen items. These items may be, for example, dresses of different brands, materials and styles. The vertical axis represents a preference score having a range [0, 1]. The horizontal axis represents a price having a range [0, 150]. The fifteen preference/price points are numbered 1401-1415. The numbers correspond to the preference ranking of the items. Thus, point 1415 represents an item more preferred than item 1414 (for a given user) etc. Also shown are three loops numbered 1420, 1424 and 1428. Each loop encloses three preference-price efficient items. Loop 1420 encloses points 1413, 1414 and 1415, which are the three most preferred items below $150. Loop 1424 encloses points 1409, 1410 and 1411 which are the three most preferred items below $100. Loop 1428 encloses points 1404, 1406 and 1409 which are the three most preferred items below $50. In one example, the items inside each loop are the recommended items at the given price point. The preference scores are computed as the product of the item vectors and the user's preference vector, as described previously in connection with the generation of the item preference data, and are not affected by pricing. The pricing information is obtained from the seller of the items, for example, and added to the item preference data. The graph is provided for illustration only. Given the price points, the system computes the scores and selects the items to be recommended at each price point.

In another variation of the present embodiment, the pricing method comprises identifying items which may be discounted to make the items preference-price efficient. If the items are appropriately discounted, the recommendation system will recommend them. For example, if the price-point is $100 and two items, A and B, are priced at $110, the question arises whether it would be beneficial to price both items at or below $100. If the preferences of the user would not lead the system to recommend item A, then discounting item A would not cause the system to recommend it and discounting is therefore not beneficial. On the other hand, if the preferences of the user would lead the system to recommend item B at the right price, then discounting item B would cause the system to recommend it and discounting is therefore beneficial. Of course, another user may have the opposite preferences, in which case the system should recommend (to the user) a discounted item A and should not recommend (to the business) discounting item B. Furthermore, if items A and B are preference-price efficient at a higher price-point, and therefore would be recommended at the $110 price, then the system should not recommend (to the business) discounting of either item.

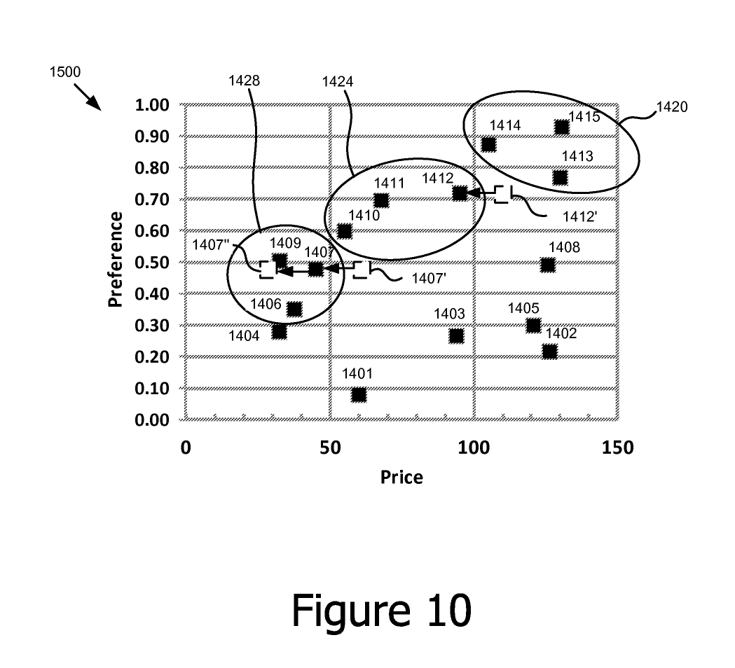

The present embodiment will now be described with reference to FIG. 10, in which a graph 1500 is presented to illustrate the selection of items which, if discounted, become preference-price efficient items. Graph 1500 is like graph 1400 except that the prices of two preference/price points, numbered 1407 and 1412, have been discounted to illustrate how to select discount candidates and discount amounts. The preference scores, initial prices (corresponding with graph 1400), new prices (corresponding with graph 1500) and discount amounts are shown in Table 7.

TABLE 7
Preference/Price Points:

| | | Initial | New | |
|---|---|---|---|---|
| Point | Preference | Price | Price | Discount |
| 701 | 0.08 | 60 | 60 | 0 |
| 702 | 0.22 | 126 | 126 | 0 |
| 703 | 0.27 | 94 | 94 | 0 |
| 704 | 0.28 | 32 | 32 | 0 |
| 705 | 0.30 | 121 | 121 | 0 |
| 706 | 0.35 | 38 | 38 | 0 |
| 707 | 0.48 | 60 | 45 | 15 |
| 708 | 0.49 | 126 | 126 | 0 |
| 709 | 0.51 | 32 | 32 | 0 |
| 710 | 0.60 | 55 | 55 | 0 |
| 711 | 0.70 | 68 | 68 | 0 |
| 712 | 0.72 | 110 | 95 | 15 |
| 713 | 0.77 | 130 | 130 | 0 |
| 714 | 0.88 | 105 | 105 | 0 |
| 715 | 0.93 | 130 | 130 | 0 |

FIG. 10 also shows the initial preference/price points corresponding with points 1407 and 1412, which are represented by dashed squares numbered 1407′ and 1412′. Arrows connect the initial and discounted points. As illustrated by graph 1500 and Table 7, discounting point 1412 from $110 to $95 shifts point 1412 so that it becomes the most preferred item below $100. Of course, point 1412 could also be priced at $99.99 to achieve the same effect.

As a result of discounting point 1412, loop 1424 now encloses points 1410, 1411 and 1412 and no longer encloses point 1409. Thus, even though an item has been discounted, the average price of the recommended items priced under $100 has increased by the substitution in the recommendation of a lower priced item (item 1409) with a higher priced item (discounted item 1412). In the same manner, point 1407 can be discounted to substitute it for point 1404 in the recommendation of items priced under $50, as shown on FIG. 10. Even further, point 1407 can be further discounted, as shown by the dashed square numbered 1407″, to make it the most preferred item at its discounted price.

FIGS. 9 and 10 also illustrate that the most preferred items below given price points could be up-charged without causing them to lose their place in the recommendation. For example, point 1409 is the most preferred item under $50, so it could be priced between $1 and $49 without changing its place in the recommendation, as the most preferred item priced under $50 for that user. Thus, the difference between the price of an item and the next highest given price barrier represents an up-charge opportunity, and the difference between the price of an item that would not be recommended at its current price and the next lowest given price barrier represents a discount opportunity. Similarly, the price difference between two items, in which the more preferred item is priced lower than the less preferred item, represents an up-charge opportunity for the more preferred item and a discount opportunity for the less preferred item, which would make each item the most preferred at their new price.

Another observation is that discounted item 1407 (FIG. 10) is less preferred. In a variation of the preceding embodiments, the system computes discounts and up-charges to maximize sales or profit. In one example, the system identifies a number of discounts which may be applied to an item to cause the system to recommend the item based on the preference-pricing methods described above. Each discount will result in a different ranking for the item. For example, the item may be recommended first at a steep discount and third at a smaller discount. For each discount, sales volume and profit increases are forecasted. Based on the forecast, the system recommends a discount to maximize sales or profit or both. In a variation thereof, the system also forecasts volume loses of other items that would be recommended by the system if the discount to another item were not applied, and selects a discount that maximizes sales volume or profit overall. With reference to FIG. 10, for example, the system would compute the impact on sales and profit of (a) discounting item 1412 so that it is recommended, and (b) not recommending item 1404, as a consequence of recommending item 1412.

In another embodiment, a system as described with reference to FIG. 1 is utilized to collect retail data. In one example, the retail data relates to a merchant. In another example, the retail data is collected across merchants. In the present embodiment, a plurality of respondents utilizing user devices, for example user device 104, complete surveys which are processed by system 130 to compute preference vectors. System 130 may also receive information concerning the characteristics of the respondents sufficient to group the respondents based on similar characteristics. System 130 then computes group preference vectors. The surveys may be directed to a plurality of item types (e.g. movies, clothing etc.) and subtypes (e.g. dresses, shirts). The respondents may complete the surveys to obtain a recommendation, as discussed previously. The respondents may complete the surveys in exchange for rewards, such as points. The respondents may also complete the surveys because they find the surveys fun or for any other reason. System 130 also collects pricing information on a multitude of items. For example, system 130 may obtain pricing information by mining the websites of merchants and may also receive pricing information directly from merchants in the form of databases or data files. With the pricing and survey information, system 130 then identifies pricing discount and up-charge opportunities for the merchants of the items.

In one embodiment of a pricing method, the system described in the preceding paragraph is utilized to recommend pricing opportunities to a merchant. In the present embodiment, a party (a) receives the survey information, (b) receives the pricing information, (c) computes item vectors based on the survey information, (d) identifies pricing opportunities, and (d) recommends the pricing opportunities to the merchant. In one example, the party transmits a pricing opportunity list to the merchant on a periodic basis. In one variation, the period basis is twenty-four hours. In another variation, the party transmits a pricing opportunity list to the merchant at least twice daily.

In another embodiment of a pricing method, the system described above is utilized to promote sales by a merchant. In the present embodiment, a party other than the merchant (a) receives the survey information, (b) receives the pricing information, (c) computes item vectors based on the survey information, (d) identifies pricing opportunities, and (d) executes sales contracts implementing pricing changes based on the pricing opportunities. The sales are fulfilled by the merchant based on the sales contracts. In one example, the party receives pricing changes limits from the merchant, and the pricing changes are implemented by the party within the limits. In one variation, the party makes sales offers and receives offer acceptances via a virtual storefront, and receives commissions from the merchant based on the sales contracts. In one example, the commissions are based on the pricing changes.

In another embodiment of a pricing method, a trade-off value is received and used to recommend prices. A trade-off value can be thought of as the amount of preference score bought for a unit of price. In other words, the trade-off value can be thought of as the difference in preference scores for an item as compared to the item plus a unit of price. For example, if an item has a preference score of 90, and the same item plus one dollar has a preference score of 92, the trade-off value is 2. In one example of the present embodiment, scores considering the trade-off values are compared to scores of other items to predict the amount of trade-off that results in a different user decision. Pricing information including a price for an item considering the trade-off can be output, with the expectation that the price will affect the user's decision e.g. purchase the item at the given price instead of another item. The trade-off value can be obtained empirically and provided in a data structure or via a user interface, and is thereby received by a computing device and stored in memory for immediate or later use. In one example, the trade-off value is determined by discounting an item until it sells, in which case the trade-off value is the discount amount that results in the sale. The trade-off value can also be determined by offering choices to respondents, such as two items priced at different prices, and asking the respondents to select one or the other. Price differences can then be used as trade-off values. To simulate the effect of the trade-off value, scores are calculated with the trade-off values. In one example, the trade-off values are used as follows:

new score=score[computed as above]+{Difference(budget−price)*trade-off}

The preferences of users can also be used to simulate or model pricing information. The simulated pricing information may be simulated by a merchant or may be output by a service provider for the merchant. In one example, user preferences are simulated by reduced dimensionality preference simulation application 136, and the simulated user preferences are used in a further simulation of user decisions, also by reduced dimensionality preference simulation application 136, to generate simulated pricing information. The simulated pricing information can be used by the merchant to price items and to implement pricing strategies to advance business objectives. The simulated pricing information may be input into known or future developed pricing software, e.g. pricing software module 198, that implements the pricing strategies. As used herein, simulated pricing information comprises information generated by simulating user decisions based on user preferences, actual or simulated. As described herein, exemplary simulated pricing information includes item prices; relative demand for an item; price elasticity for an item; cross-price elasticity for demand of an item and a price of a second item; a demand curve for an item; demand curves for an item corresponding to different subpopulations; and any other information suitable for making pricing decisions. While pricing is generally described herein with reference to items, it should be understood that items include any good or service which may be priced. Exemplary items include goods which may be purchased, leased or rented, and services which may be received or attended. For example, a roller-coaster ride in an amusement park is a service which is attended, while a lawn treatment service is a service which is received.

In one embodiment, a pricing method is executable in part by a processing device according to processing instructions embedded in one or more non-transitory computer readable medium. In one variation of the present embodiment, executable with a reduced dimensionality preference simulation application, by a service provider or a merchant, the method comprises accessing item preference data; reducing the dimensionality of the item preference data to obtain item preferences of items; simulating preferences of users with the item preferences; and simulating user decisions with the simulated user preferences to generate simulated pricing information. In one example thereof, the item preferences are based on a predetermined number of preference drivers, and the method further comprises calculating variation unexplained by the predetermined number of preference drivers. In another example thereof, simulated pricing information comprises at least one of relative demand for an item; price elasticity for an item; cross-price elasticity for demand of an item and a price of a second item; a demand curve for an item; and demand curves for an item corresponding to different subpopulations.

In another variation of the present embodiment, executable by a merchant, the method comprises identifying a user based on website access information; outputting information about the user to a reduced dimensionality preference simulation application via an information network, the reduced dimensionality preference simulation application configured to simulate preferences of users based on reduced dimensionality item preference data and generate simulated pricing information with the information about the user and the simulated preferences of users; receiving the simulated pricing information from the pricing system; and offering a price, corresponding to an item, to the user based on the simulated pricing information. In one example thereof, the simulated pricing information comprises at least one of relative demand for an item; price elasticity for an item; cross-price elasticity for demand of an item and a price of a second item; a demand curve for an item; and demand curves for an item corresponding to different subpopulations.

In one variation, a reduced dimensionality preference simulation application assumes that, at least sometimes, a potential purchaser will not purchase the preferred item. A probability is introduced, e.g. 80%, to account for this behavior. The probability affects the frequencies of the analysis item and thereby the demand curve. The actual user may choose different items for many reasons, such as already having the preferred item. Another possibility is that the preferred item is similar to other items the user has. This variation can be simulated by assigning lower probabilities to similar items. The similarity of items can be calculated by performing a likelihood analysis with content attributes associated with the items. The content attributes may include color, accessories, material, brand, country of manufacture, and the like.

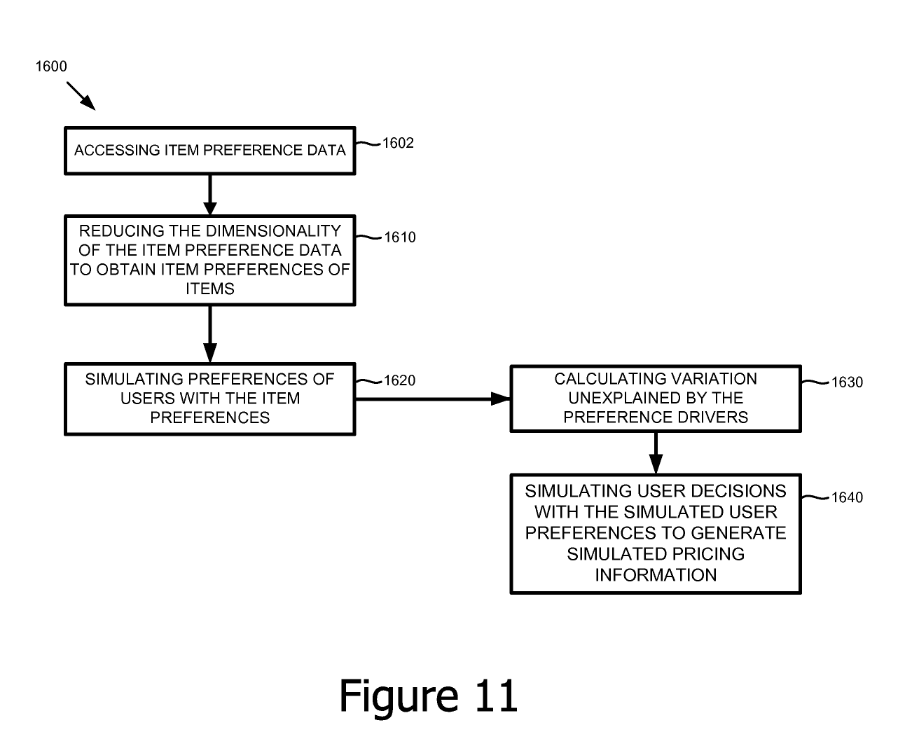

A further variation of the present embodiment will be described with reference to FIG. 11. The method includes:
1602. Accessing item preference data;
1610. Reducing the dimensionality of the item preference data to obtain item preferences of items;
1620. Simulating preferences of users with the item preferences;
1630. Calculating variation unexplained by the preference drivers; and
1640. Simulating user decisions with the simulated user preferences to generate simulated pricing information.

Aspects of the method referred to by numerals 1602 and 1610 have been described previously and are summarize here for convenience. The item preference data may be accessed, at 1602, by reading a data structure from non-transitory memory including item preference information received from respondents. Based on the item preference data, item preferences are calculated, at 1610, using any known dimensionality reduction technique, e.g. PCA, including those described hereinabove with reference to FIGS. 3, 3A, 4 and 7. The item preferences comprise attributes of drivers which may be expressed as item vectors (if four drivers are selected, each vector includes four attributes) or equivalent mathematical representations. The dimensionality reduction technique also yields variances for each driver, including for the unselected drivers. The variances of the unselected drivers represent the variation unexplained by the selected drivers. In the present context, the selection of drivers occurs automatically by programming the system to identify a number of drivers, e.g. four drivers. The drivers which explain the most variation are identified, and the variation corresponding to the remaining drivers represents unexplained variation.

At 1620, user preferences are simulated. The simulation is performed to predict the decision behavior of purchasers. The simulation is performed by simulating as many preference attributes as there are selected drivers. In one example, the attributes are calculated by multiplying, for each attribute, a random number times the variance of the item preferences (e.g. attribute 1=var1*rnd1; attribute 2=var2*rnd2; attribute 3=var3*rnd3; attribute 4=var4*rnd4). In another example, the first attribute is calculated as attribute 1=mean 1+var1*rnd1, where mean1 is the average of the attributes of the item preferences corresponding to the first selected driver.

At 1630, unexplained variation is calculated. The item preferences are based on the selected preference drivers, as explained above. The variation of the unselected drivers is calculated, which represents variation unexplained by the subset of preference drivers. The variation of the unselected drivers can be calculated as the standard deviation of the unselected drivers, as follows:

$$\sqrt{\sum var ( all attributes ) - \sum var ( selected driver attributes )}$$

At 1640, user decisions are simulated with the simulated user preferences to generate simulated pricing information. User decisions may be simulated using item scores calculated by multiplying, for each item, the attributes of the user preferences and the item preferences, and adding an error value, calculated as a random value times the standard deviation of the unselected drivers. Other means of calculating error values may also be used. For example, an error value may be predetermined in an arbitrary manner and improved empirically over time for different types of items. To perform the simulation, an item may be identified based on the score, as described hereinabove. As the simulation is repeated, different items will have the maximum score. The frequency at which a particular item receives the maximum score is used to simulated user decisions relative to the item. The user decisions can be affected by changing item prices, for example, to determine the effect of pricing on the decisions. In one example, a price limit, or budget, is received and the identified item is the item priced at or below the price limit and having the maximum score. In another example, the price limit is simulated and the identified item is the item priced at or below the price limit and having the maximum score. Many price limits can be simulated to simulate pricing information including demand curves and pricing sensitivities. The present embodiment of a pricing method, and variations thereof, may be performed by a reduced dimensionality preference simulation application, which may include dimensionality reduction processing sequence 332.

In embodiments of pricing methods described herein, item prices and price limits may be associated with items. In the case where item preferences of the items are represented as vectors, the association comprises appending to each item vector the price of the item and/or the price limit. The price limit may be a received budget (e.g. a budget input with a user interface to simulate a purchaser's budget) or a simulated price limit. The price limit represents a maximum amount a purchaser may wish to spend. The computations take the price limit into account so that the identified item is not priced above the price limit.

Decision behavior may be simulated using Monte Carlo simulation. A number of user decisions may be simulated to determine pricing elasticity, cross-pricing elasticity and other pricing relationships. Preference vectors may be simulated from probability distributions for each user. The preference vectors may then be used to identify simulated decisions for a number of simulated users. The number of times that an item was “chosen” in a simulation divided by the total number of simulations run gives the relative demand of the item. The simulations may be constrained by price limits and other suitable factors.

In one example, decision behavior is simulated based on a budget distribution. The budget distribution may be derived from information received via a merchandizing website. The merchandising website may permit users to select maximum prices for items. A filtering engine associated with the website may limit the item choices presented to the users based on the limits selected by the users. A budget distribution may comprise the relative frequency of the maximum prices selected by the users.

In one variation of the present embodiment, a demand curve for an item is simulated by determining the relative demand for the item at each of a plurality of prices. Normal distributions may be assumed for the user preferences to simulate purchasing behaviors dependent on prices of items. The results of the simulation provide simulated user preferences and prices that would influence the purchasing behavior of actual users. To determine the relative demand, a threshold price is determined at which, in the simulation, a user decisions items at or below the threshold. In other words, the system finds a price low enough that the item becomes preferred to all other items with equal or lower prices. The item may be priced at or near $0, if necessary. The process of determining thresholds is repeated for multiple simulated users. The relative demand for an item at a given price is the percentage of times that the threshold price is at or above the given price. Preferred items were described above in connection with price-efficient items with reference to FIGS. 9 and 10.

In another variation of the present embodiment, the price elasticity of demand for an item is calculated using the demand curve. Price elasticity represents the effect of a price change on demand at a given starting price. In other words, price elasticity may be calculated as the percent change in demand for a given change in price for a given starting price. Price elasticity may be derived from the demand curve by finding relative demand at two prices, finding the ratio of the absolute difference between the relative demands and the difference between the two prices, and then dividing the ratio by the relative demand at a price intermediate the two prices. For example, relative demand may be calculated by finding the relative demand at the given starting price, a second relative demand at a price of 1% above the starting price and a third relative demand at a price of 1% below the starting price. The second and third relative demands are subtracted from each other and then divided by 2 (e.g. 1%+1%). The absolute value of the resulting number is then divided by the first relative demand. If the relative demands were calculated at prices +/−10% instead of 1%, the difference between the relative demands is divided by 20 instead of 2. In another example, the demand curve is fitted with a smooth function before the elasticity is calculated.

In a further variation of the present embodiment, the cross-price elasticity of demand is calculated for an item relative to a second item. The cross-price elasticity is the change in demand for an item relative to a change in price for the second item, given starting prices for both items. To obtain the cross-price elasticity, the demand curve for the item with respect to the price of the second item is calculated (e.g. y axis is demand for the item and x axis is the price of the second item). The calculation is as described above with reference to a demand curve, except that the threshold price is the price for the second item at which the user will decide to purchase the first item. It is possible that a threshold price will not exist to satisfy the preceding statement. The cross-price elasticity is then calculated from the demand curve as described above.

In yet another variation of the present embodiment, a budget elasticity of demand is calculated for an item. The budget elasticity is the change in demand for an item given a change in budget. The budget elasticity may be calculated by determining the relative demand for the item given an assumed budget distribution. Then, the relative demand is recalculated using another budget distribution assumption. In another embodiment, the budget distribution can be shifted up and down by 1% to determine the percentage increase in demand for each percentage increase in budget.

In a further variation of the present embodiment, price elasticity is used to maximize revenue. In one example, the price of an item at which price elasticity equals 1 maximizes revenue. Price elasticity can be used to maximize or minimize many business metrics based on known economic equations.

In a yet further variation of the present embodiment, subpopulation preferences are simulated to determine demand curves for different types of actual users. First, a large set of user decisions are simulated. Then, simulated users are grouped according to their preferences. In one example, users are grouped into four subpopulations based on the attributes of the second and third preference drivers. (e.g. PC2+PC3+, PC2+PC3−, PC2−PC 3+, and PC2−PC 3−). In another example, users are grouped into eight subpopulations based on the attributes of the second, third and fourth preference drivers. The relative demand, demand curve, price elasticity, cross-price elasticity, budget elasticity, and any other suitable pricing relationship may be calculated to simulate the purchasing behaviors of the subpopulations. Additional granularity may be obtained by selecting, via programming, additional preference drivers to permit grouping into more subpopulations. Before or after the simulations, the actual preferences of actual users are obtained, as described below. The user's preferences are then matched to one of the subpopulations, and the pricing relationships of the subpopulation are used to make pricing decisions for the user. The simulations may be performed by a reduced dimensionality preference simulation application.

The preferences of actual users can be obtained in any suitable manner. In one example, user preferences are obtained beforehand with user surveys configured to elicit said preferences, as described above. User preferences may also be obtained based on the user's historical information, such as browsing or purchasing history. A merchant's website may track historical information based on a user's access to the website. Historical information may also be purchased from marketing organizations.

In another embodiment of a pricing method, simulated pricing information representing pricing relationships generated with a first software program are provided to a second software program. The first software program comprises instructions to reduce the dimensionality of item preference data and simulate the simulated pricing information based on the reduced dimensionality item preference data. The second software program comprises known pricing software configured to implement business drivers or pricing goals. Exemplary pricing goals include defining pricing strategies to increase profit, volume or both, and optimizing mark-downs to clear inventories. Simulated pricing information includes demand curves, relative demand, price elasticities, cross-price elasticities, budget elasticities, and any other pricing relationship information simulated as described above. In one variation thereof, a third software program is provided which is configured to communicate information from the second software program to the first software program so that the first software program can determine the pricing parameters. The second and third software programs may reside in a merchant's physical server while the first software program may reside in a remote server and be accessible to the third software program via an information network. The first software program may be referred to as a reduced dimensionality preference simulation application.

A merchant may access an API, for example, to access a database of potential purchaser preferences and demand curves. When an actual user is on the website of the merchant, the merchant can access the API, for example, to provide a user identification and information about an item, which may be referred to as the analysis item. The first software program may comprise a reduced dimensionality preference simulation application that matches the user to the user preferences stored in the computer memory, and outputs a demand curve (or any other pricing parameters or relationships) for the analysis item. The demand curve flows through the API to the merchant. The merchant can then make a pricing decision for the analysis item based on the demand curve for the particular user based on existing user preferences of the user. Based on the demand curve, the merchant can select a price for the analysis item to maximize a desired business driver or objective. Exemplary business drivers or objectives include profits, volume, inventory reduction, under-pricing competition on particular items, maximizing the value of promotions, etc.

More generally, a pricing system may comprise one or more physical servers and a web server software residing in the one or more physical servers and operable to output item information including item prices for viewing by potential customers. The pricing system also includes a pricing software module or application operable to receive simulated pricing information and generate the item information based on the simulated pricing information. The simulated pricing information is generated by a reduced dimensionality preference simulation application operable to reduce the dimensionality of item preference data to obtain item preferences of items, simulate preferences of users with the item preferences, and simulate user decisions with the simulated user preferences to generate the simulated pricing information. The web server software is further operable to process a sales transaction based on the item prices presented for viewing by the potential customers.

As used herein, an application, algorithm or, processing sequence, is a self consistent sequence of instructions that can be followed to perform a particular task. Computer software, or software, executes an algorithm and can be divided into application software, or application, and systems software. An application executes instructions for an end-user, or user, where systems software consists of low-level programs that operate between an application and hardware. Systems software includes operating systems, compilers, and utilities for managing computer resources. While computing systems typically include systems software and applications software, they may also operate with software that encompasses both application and systems functionality. Applications may use data structures for both inputting information and performing the particular task. Data structures greatly facilitate data management. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

As used herein, a computing device may be a specifically constructed apparatus or may comprise general purpose computers selectively activated or reconfigured by software stored therein. The computing device, whether specifically constructed or general purpose, has at least one processor, or processing device, for executing machine instructions, which may be grouped in processing sequences, and access to memory for storing instructions and other information. Many combinations of processing circuitry and information storing equipment are known by those of ordinary skill in these arts. A processor may be a microprocessor, a digital signal processor (“DSP”), a central processing unit (“CPU”), or other circuit or equivalent capable of interpreting instructions or performing logical actions on information. Memory includes both volatile and non-volatile memory, including temporary and cache, in electronic, magnetic, optical, printed, or other format used to store information. Exemplary computing devices include workstations, personal computers, portable computers, portable wireless devices, mobile devices, and any device including a processor, memory and software. Computing systems encompass one or more computing devices and include computer networks and distributed computing devices.

As used herein, a computer network, or network, is a system of computers or computing devices interconnected in such a manner that messages may be transmitted between them. Typically one or more computers operate as a “server”, a computer with access to large storage devices such as hard disk drives and communication hardware to operate peripheral devices such as printers, routers, or modems. Other computers, termed “workstations”, provide a user interface so that users of computer networks can access the network resources, such as shared data files, common peripheral devices, and inter workstation communication.

As used herein, portable wireless devices include mobile phones, personal digital assistants, tablets, laptop computers, and any other portable devices with wireless connectivity.

Embodiments of the disclosure may be implemented in “object oriented” software. The “object oriented” software is organized into “objects”, each comprising a block of computer instructions describing various procedures to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a mouse pointer or touch-screen to generate an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access.

As used herein, the transitional term “comprising”, which is synonymous with “including,” or “containing,” is inclusive or open-ended and does not exclude additional, unspecified elements or method steps. By contrast, the transitional term “consisting” is a closed term which does not permit addition of unspecified terms.

Embodiments of an information elicitation and recommendation method and system have been described for eliciting information from users and for recommending items to users based on the elicited information. According to embodiments of the method, item preference data, initially obtained from respondents, is analyzed to identify pseudo-independent items. The pseudo-independent items are used to administer a survey to one or more users. The user's responses define the user's preference drivers. Recommendation items are identified based on the user's preference drivers. The identified items are presented to the user(s). User can also switch-out items presented in the survey questions if they are unfamiliar with the items. The switch-out information can be used to better select questions for the same user in the future so as to not ask redundant questions that degrade the user experience. The foregoing functions are implemented with processing sequences embedded in memory. Some or all of the processing sequences may be embedded in the memory of a system according to one embodiment of the disclosure. Some of the processing sequences may be imbedded in a memory of a user device operable to administer the survey and present the recommendations. Of course, the functions implemented by the processing sequences may be distributed in different arrangements defining variations of the foregoing system embodiments without departing from the teaching of the disclosure. Several embodiments and examples were described with reference to movies for illustration purposes. However, the concepts illustrated by the embodiments and examples are also applicable to any items. Exemplary items include clothing, jewelry, electronics, food items etc.

Further, embodiments of a pricing method and system have been described. In some embodiments, preference drivers enable the system to suggest pricing decisions to maximize income or profit or both. In other embodiments, pricing relationships and parameters characteristic of the pricing relationships are provided to known pricing software to make the pricing decisions. The pricing relationships and parameters characteristic of the pricing relationships are determined by using reduced dimensionality preference data to simulate user decisions.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A pricing method executable at least in part by a processing device according to processing instructions embedded in one or more non-transitory computer readable medium, the method comprising:
accessing item preference data;
reducing the dimensionality of the item preference data to obtain item preferences of items;
simulating preferences of users with the item preferences; and
simulating user decisions with the simulated user preferences to generate simulated pricing information.

2. A method as in claim 1, wherein the item preferences are based on a predetermined number of preference drivers, further comprising calculating variation unexplained by the predetermined number of preference drivers.

3. A method as in claim 1, wherein the simulated pricing information comprises a price for an item that maximizes a desired business driver.

4. A method as in claim 1, further comprising receiving a price limit, wherein the simulated pricing information comprises an item priced below the price limit.

5. A method as in claim 1, further comprising receiving a trade-off value, wherein the simulated preferences of users are based on item prices including the trade-off value.

6. A method as in claim 1, further comprising assuming a probability that an item will not result in a business transaction, and identifying a second item using the probability.

7. A method as in claim 1, further comprising assuming a probability that items similar to other items are less likely to generate a business transaction, and identifying a second item using the probability.

8. A method as in claim 7, further comprising determining that the items are similar to the other items based on content attributes associated with the items and the other items.

9. A method as in claim 1, wherein the simulated pricing information comprises relative demand for an item.

10. A method as in claim 1, wherein the simulated pricing information comprises price elasticity for an item.

11. A method as in claim 1, wherein the simulated pricing information comprises cross-price elasticity for demand of an item and a price of a second item.

12. A method as in claim 1, wherein the simulated pricing information comprises budget elasticity for an item.

13. A method as in claim 1, wherein the simulated pricing information comprises a demand curve for an item.

14. A method as in claim 13, wherein the simulated pricing information comprises additional demand curves for the item, the demand curves corresponding to different subpopulations.

15. A method as in claim 14, further comprising receiving a user identification to identify a user, selecting one of the demand curves based on user preferences of the user, and outputting the selected demand curve.

16. A method as in claim 15, wherein the receiving and the outputting is performed through an application programming interface.

17. A method as in claim 14, further comprising determining, for each subpopulation, a price for the item based on the corresponding demand curve.

18. A method as in claim 14, further comprising selecting one of the demand curves based on user preferences of a user and determining a price for an item based on the selected demand curve.

19. A method as in claim 18, further comprising charging the price to the user.

20. A method as in claim 1, wherein the simulated pricing information comprises price elasticities for an item, the price elasticities corresponding to different subpopulations.

21. A method as in claim 20, further comprising selecting one of the price elasticities based on user preferences of a user.

22. A method as in claim 21, further comprising outputting the selected price elasticity or a price for an item determined from the price elasticity.

23. A method as in claim 22, wherein the outputting is performed through an application programming interface.

24. A non-transitory computer readable medium having processing instructions embedded therein configured to implement a pricing method when executed by a processing device, the method comprising:
accessing item preference data;
reducing the dimensionality of the item preference data to obtain item preferences of items;
simulating preferences of users with the item preferences; and
simulating user decisions with the simulated user preferences to generate simulated pricing information.

25. A pricing method executable at least in part by a processing device according to processing instructions embedded in one or more non-transitory computer readable medium, the method comprising:
identifying a user based on website access information;
outputting information about the user to a reduced dimensionality preference simulation application via an information network, the reduced dimensionality preference simulation application configured to simulate preferences of users based on reduced dimensionality item preference data and generate simulated pricing information with the information about the user and the simulated preferences of users;
receiving the simulated pricing information from the reduced dimensionality preference simulation application; and
offering a price for an item to the user based on the simulated pricing information.

26. A pricing method as in claim 25, wherein the simulated pricing information comprises at least one of relative demand for an item; price elasticity for an item; cross-price elasticity for demand of an item and a price of a second item; a demand curve for an item; and demand curves for an item corresponding to different subpopulations.

27. A pricing system comprising:
one or more physical servers;
a web server software residing in the one or more physical servers and operable to output item information including item prices for viewing by potential customers; and
a pricing software module operable to receive simulated pricing information and generate the item information based on the simulated pricing information, the simulated pricing information generated by a reduced dimensionality preference simulation application operable to reduce the dimensionality of item preference data to obtain item preferences of items, simulate preferences of users with the item preferences, and simulate user decisions with the simulated user preferences to generate the simulated pricing information;
wherein the web server software is further operable to process an item transaction based on the item prices presented for viewing by the potential customers.
